(19) United States
(12) Patent Application Publication
(10) Pub. No.: US 2008/0077780 A1
(43) Pub. Date: Mar. 27, 2008

(54) System and Method for Software Debugging

(76) Inventor: Arthur R. Zingher, San Diego, CA (US)

Correspondence Address: Willian J Kolegraff;Law Office of Bill Kolegraff, 3119 Turnbery Way, Jamul, CA, 91935, US

(21) Appl. No.: 10/565,618

(22) PCT Filed: Jul. 23, 2004
(86) PCT No.: PCT/US04/23689

§ 371 Date: Jan. 24, 2006

Related U.S. Application Data
(60) Provisional application No. 60/490,180, filed on Jul. 25, 2003.

(51) Int. Cl. G06F 9/00

(52) U.S. Cl. 712/227; 712/E09.06

(57) ABSTRACT

The software debugging system provides a processor that is executing a software process, and the software process has a bug or other failure. A fast-response reporter circuit connects to a low level asset in the processor, such as a reorder buffer, commit buffer, or high speed data path. The fast response reporter circuit is configured to selectively extract data from the low-level asset, and the extracted data is transmitted to an evidence file for review and analysis. In one arrangement, a fast-response sentry circuit also connects to a low-level asset in the processor, and is configured to monitor for a predefined event. When the predefined event occurs, the fast-response sentry circuit causes an action to occur, such as activation of the reporter fast-response circuit.

### CROSS REFERENCE TO RELATED APPLICATIONS

This application claims priority to U.S. provisional patent application No. 60/___,___, filed Jul. 25, 2003, entitled “Bug Tracer: Better Tool & Method to Diagnosis Software Bugs”, which is incorporated herein by reference.

### STATEMENT REGARDING FEDERALLY SPONSORED RESEARCH AND DEVELOPMENT

Not applicable.

### REFERENCE TO A COMPUTER LISTING, A TABLE, OR A COMPUTER PROGRAM LISTING COMPACT DISK APPENDIX

Not applicable.

### BACKGROUND OF THE INVENTION

1. Field of the Invention

The present invention relates generally to the field of hardware and software tools for software code debugging. More particularly, the present invention relates to a configurable hardware circuit interacting with a processor for the collection of debugging data.

2. Description of Related Art

Software debugging is the process of locating and fixing errors in a software program. Many tools have been developed to assist a developer in this process, but the debugging process continues to be time consuming, frustrating, and generally unpredictable. In the debugging process, there is a software developer, a computer system, and a central-program with an undiagnosed bug. The central-program can execute upon the computer system, and produces at least one symptom of failure that is visible to the developer. The developer may have limited understanding of the central-program, or may have limited understanding of the particular symptom identified. Accordingly, the developer may struggle to diagnose the bug, and worse, may even introduce additional errors into the program while attempting to diagnose the cause of the failure. It would be desirable to enable the operator to diagnose this bug, irrespective of specific experience. However, bugs vary quite widely in type and diagnostic difficulty. Therefore it is appropriate to consider an ensemble (range) of central-programs and bugs. For many software projects, the cost and risk are strongly correlated with the time and risk to debug the software program.

Classical debugging programs enable a sophisticated developer to examine the execution step by step. In some very simple cases, it is sufficient to execute and examine just once. Much more often, it is necessary to execute many times, and to look successively earlier in the execution results. Debugger breakpoints and other semi-automatic tools are helpful. Nevertheless, such tools and methods are very clumsy. For a simple program with brief execution, this may be clumsy but adequate to diagnose a simple bug. For a complex program with long execution, often this is painfully difficult to diagnose a bug, particularly a subtle bug. In software, the “cause” (bug) precedes the effect (symptom) of the failure. Therefore the developer must find a point in history that lead to a current failure condition.

Many prior tools and methods are effective only when a developer has a hypothesis which is “close” to the Bug. This may be useful for an expert, who is very familiar with the central-program, tools and methods. When the hypothesis is “far” from the bug, then prior tools and methods typically are not very effective. Therefore too often, these are inefficient for a non-expert developer, who is just starting to try to diagnose a symptom. Prior tools and methods for debugging software provide relatively little relevant evidence. These are useful only “close” to the bug. However, such little relevant evidence often is not adequate to guide diagnosis starting with a hypothesis “far” from the bug. Often it is not adequate just to interrupt execution at a specified event, and then to proceed by “single-step” human methods; or to collect evidence with small bandwidth or with small logical size; or to collect huge amounts of irrelevant evidence. These problems hinder many prior tools and methods for debugging.

Computer system typically include a hierarchy: L1 cache, L2 cache, main memory, storage, plus related buses and controllers. This provides highly engineered resources to save and transfer data with large data-rate and large logical size, and means for sharing resources (memory space, bus bandwidth) between different execution threads, and different data sets. Also this hierarchy is already amortized by prior computer goals.

Some prior tools and methods used software-level means to extract and save evidence during execution. However this greatly degrades speed of execution, maximum bandwidth for evidence, and maximum logical size for evidence. Even using the memory and storage hierarchy hardware, it is not feasible to extract and save all possible execution data to the evidence file. (Some terms are useful in computer engineering. “Giga” is a prefix that means “1 billion” or 10 raised to the power 9. A byte is a measure of data. One byte contains 8 bits, and can specify 1 of 256 possibilities. For example a keyboard character can be encoded as one byte.) More particularly, consider every instruction that writes to memory. In present-day systems, a representative CPU clock is 2.0 Giga Cycles/Sec. On average, suppose the CPU writes to memory about 8 bytes every 10 cycles. Thus the average data-rate is: 8*2.0/10=1.6 Giga Bytes/Sec.

Next consider the bandwidth of the bus to main memory. A representative bus has frequency and width of about 0.1 GigaHz and 8 Bytes. The nominal bandwidth may be about 0.8 Giga Bytes/sec. Because of queuing effects, suppose the useable bandwidth is at most 50% of this. Also, this bus must be shared between the central-program and the software debugging program, and this introduces another likely factor of about 50%. Thus the allowable bandwidth for debugging evidence is 0.8*0.5*0.5=0.2 Gigabits/sec. Thus bus bandwidth restricts the evidence data-rate by a mismatch ratio of about 8×.

The actual mismatch may be considerably larger. Often, a modem general-purpose processor chip has multiple processors. Typically, each contain multiple functional units, and means to operate these simultaneously (Instruction Level Parallelism or ILP). By contrast, a single memory and storage hierarchy serves all these multiple processors and multiple function units. Each factor multiplies the mismatch ratio. Also, Moore's law continues each year, so the CPU clock is getting faster, while bus and memory bandwidth improve much more slowly. Other queuing effects may further reduce the useful bandwidth. The bus from main memory to storage might have less bandwidth than the bus from CPU to main memory. The memory controller may cause inefficiency. Switching memory bus direction and switching memory between read and write may cause inefficiency. An unattractive solution is to reduce the CPU speed by 8× or more. This may complicate coordination with other functions, and greatly complicate diagnosis of time-sensitive bugs. Also this will slow down execution to extract and save evidence. Nevertheless, a milder reduction might be tolerable.

Logical size introduces further limits. Suppose there were 1,000 seconds=16.6 minutes between the bug and the symptom. To record all the data generated in this time would require about 12,800 Gigabits or 1,600 Gigabytes of evidence file. This is overwhelming for storage and use. Examination of the evidence file works at vastly slower rates. Even more strongly, this restricts the feasible size of the evidence file. Thus, even using the hierarchy hardware, there are practical constraints on the short-term data-rate for evidence, and the long-term logical size of the evidence file. Some prior tools and methods often provide evidence which is overwhelming and very inefficient. Using manual methods, it is very difficult to find a tiny “needle” of pivotal evidence in a huge “haystack” of irrelevant evidence. Unfortunately, very selective automatic tools often are useful only after a operator knows what to select. Also, very selective automatic tools often are difficult for a less-specialized operator. Some prior tools & methods require human labor that increases linearly with execution distance (number of executed instructions) between the bug and an instruction selected by automated means. If the execution distance is small, then this may be feasible. If the execution distance is sufficiently large, then this is unfeasible. For example, using a classical debugger during one work-day, it is unfeasible for an operator to look carefully at the display for each of 1,000,000 distinct time-steps. However, such a large execution distance is relatively common.

In a typical computer and processor, memory hierarchy includes three levels: L1 cache, L2 cache, and main memory. For each of these, the processor chip hardware includes a controller for each level. However, there is typically not a hardware controller for storage. Instead, there is a software controller that is part of the operating system. For example, this provides software methods to support a memory mapped file. Thus an address range in virtual memory is transparently coupled with a file in storage.

In a computer system, there is an Instruction Set Architecture (ISA) that defines the actions and syntax of all legal instructions and data. This defines the operation of the computer seen by the Machine-Level Software (MLSW), particularly the executable-code. Some computer functions are supported at levels deeper than the ISA and MLSW. These computer functions are typically supported in hardware or firmware, and generally provide the foundation under ISA and MLSW. Typically these functions operate with little explicit disruption to execution of MLSW. In general, these functions are “transparent” or “automatic” compared to the ISA and MLSW, and can be “taken for granted” by the ISA and MLSW. Such functions will be called “deep-level resources” or low-level assets. For example, as described below, the memory hierarchy, storage registers, data paths, and the reorder buffer are deep-level resources.

In a typical computer, other features are not deep-level resources, but relative to high-level software source code, those resources are still “transparent” and “automatic” and can be “taken for granted” by high-level source-code and the developer. In the following, two examples are (i) support for the call stack and (ii) support for memory mapped files. Known systems provide several different modes for software (particularly ISA compliant MLSW) to specify an address in memory. The first mode is an address, or more precisely a “virtual address”. A second mode is a “subscripted address”. This is formed by adding a “starting address” and an “offset”. This is useful in many data structures, such as a matrix. A third mode is an “indirect address”. The original address is used as pointer to a memory location which provides the ultimate address. In some cases, a chain of indirect addresses may lead to the ultimate address. Other computers provide additional address modes. In a representative computer, the support for address modes is a deep-level resource, that is transparent to the MLSW.

In a typical computer system, the memory is logically divided into sectors, and each sector has a security classification. In one example, security classification values correspond to: data for applications; archives for applications; programs for applications; data for outer system functions; programs for outer system functions; kernel system programs; high-security data; and high security programs. The operating system assigns a security status to each thread. As the thread executes, it requests access to a sector in memory. The system compares thread status and sector classification, and hence allows or thwarts this access.

The computer also typically has a memory hierarchy with several levels, with a progression of logical size and access latency. L1-cache is smallest and fastest; L2-cache is medium-large and medium-slow; L3-cache is larger, slower and optional; and main memory is very much larger and slower. L1-cache is divided into two distinct parts: one for instructions, and one for data. L1-cache and L2-cache both are located on the same chip as the processor. This enables low level data busses with very large bandwidth. L3-cache may be on the processor chip, or on nearby distinct chips, or not included. Main memory is quite distinct from the processor chip. The computer also includes means to transfer data between levels in the memory hierarchy, and includes means to translate between virtual addresses and physical addresses, as described below. Typically these are deep-level resources, implemented in hardware, transparent and automatic compared to ISA and MLSW. Thus, a central-program in the CPU can use a unified virtual address space for writing data to and reading data from cache and memory. Thus the central-program does not explicitly distinguish between cache and memory.

The computer has deep-level resources (low-level assets) to transfer data between levels in the memory hierarchy. There are deep-level resources to transfer a “Line” (e.g.: 64 bytes) between L1 cache and L2 cache. Whenever the L1 cache controller needs to provide more space in the L1 cache, then a line is used to write data from L1 Cache to L2 Cache. Similarly, there are deep-level resources to transfer a “page” (e.g.: 512 bytes) between L2 cache and memory. Whenever the L2 cache controller needs to provide more space in cache, a page is written from cache to memory. The operating system defines a “call stack”. During execution, the call stack summarizes all pending methods. The call stack includes a memory range, plus several pointers: a stack pointer to the next unused address; a pointer to the head of the range; and a pointer to the tail of the range. A call to a method typically includes a vector of parameters. When a call occurs, the stack pointer is used to copy this vector and is copied onto the stack. Then the stack pointer is incremented, so it points to the next unused address. Thus the vector is “pushed onto” the call stack. As a method executes, it uses this vector for parameters, such as simple values and pointers to data. When a method is concluded, then the stack pointer is decremented. Thus its parameter vector is effectively “popped off” the call stack.

In a typical general purpose processor, there is a reorder buffer, plus means to correct data in this buffer. The data stream transferred from the reorder buffer contains the definitive and detailed description of each instruction and its results. For each executed instruction, the detailed description includes: all bits of the instruction, including the operation code (op-code); all relevant register numbers and register values; and all relevant predicate vectors (that modulate this instruction). For a memory-family (load or store) instruction, this also includes the memory address and value being transferred. For a branch-family instruction, this also includes the destination I-address selected by this instruction. The reorder buffer and these related functions are low-level assets in the form of deep-level resources.

Branch-family instructions include any instruction that could change the execution sequence. For example, this includes: Jump, Unconditional Branch, Branch and Execute, Conditional Branch, Switch, Call, Call and Link, Interrupt, and Return.

The following briefly puts this in context. In a typical computer, the central-processor supports “out of order” execution of instructions to provide faster average execution. For each instruction, as soon as its pre-requisites are available inside the processor, the instruction starts to execute. The result is stored temporarily in a “reorder buffer” (also called “commit buffer”). Later and in the correct order, these results are “committed”: transferred to registers, memory etc. In particular, this “predicts” the direction of branch-family instructions. Therefore this calculation is “speculative”. Before each result is committed, this validity is tested. Occasionally, the prediction is wrong, and the result is not valid. Therefore the instruction is calculated again, and a new result is committed. On average, the time advantage of starting execution earlier outweighs the time disadvantage of occasionally recalculation.

A circular buffer includes one or more ranges of data addresses plus pointers. For each range of addresses in a circular buffer, there is a head-pointer and tail-pointer to indicate it ends. A write-pointer guides where to write data into this buffer. As data is written, the write-pointer is incremented. When this reaches the tail of a range of addresses, then it jumps to the head of the (next) range of addresses. Thus data can be written to addresses in cyclic order in the buffer. Likewise, a read-pointer guides reading data from buffer addresses in cyclic order. Subject to limitations, data can be almost simultaneously written to and read from a circular buffer. Also subject to limitations, data can be transferred through this buffer, even though the total logical size of the data exceeds the logical size of this buffer. One limitation is: the peak data-rate must not be too large (e.g.: not exceed the bandwidth of the relevant channel). Another limitation is that the data must be decomposable as blocks smaller than the buffer.

There are several known software programs for assisting in the debugging process. For example, U.S. Pat. No. 5,784,552 describes a method to execute a program and to record a log file. At each time-step, any values newly assigned to registers or memory are recorded in the log file. After execution, this log can be examined, in a forward or reverse order, and values may be changed. Based on this, simulated execution may be resumed. Another example of a software debugging program is described in the publication “DejaVu: A Deterministic Java Replay Debugger for Jalapeno VM” by B. Alpern, J. -D. Choi, T. Ngo & M. Sridharan. “DejaVu” is a software tool that works with a special JVM. DejaVu runs in two modes, Record and Replay. When a Java program executes on the JVM, then DejaVu runs in Record mode, and stores execution data (including addresses, values, timing, external inputs) into a file. During Replay mode, this file is read and the data are replayed. This may be used to drive the JVM again. In this mode, the file and execution can be replayed in any combination of time-forward and time-backward order. Also this project included a remote debugger which works with DejaVu and the JVM. Also this project extensively addressed repeatability for playback, in spite of complications related to multiple threads of execution and timing details.

Also, “tracing” of a software program is known to assist in diagnosis software bugs. To the source code for the program, the developer adds statements to record some variables. This requires the developer to hypothesize where to insert these instructions. Often this is very difficult for the developer. This may place excessive demands on developer to understand execution of the program. This is exacerbated if the developer has inadequate familiarity with the central-program. Too often, the developer is reduced to “shooting in the dark”. Thus, tracing often is far from satisfactory for debugging. The inserted statements may also substantially interfere with the execution of the program, and may introduce new bugs to the process. Tracing systems also provide a second method: a semi-automatic or automatic process to add debugging statements at many locations in the execution code, particularly print-related statements. This has further difficulties. Often, this is severely limited in the bandwidth and logical size of evidence that can be extracted and saved. Often there is a hazard of introducing new bugs when debugging statements are added or removed. Execution time-distortion rises rapidly with the density of debugging statements. In another example, the central-program machine-code is executed on a low-level emulator. Throughout execution, the emulator effectively interpolates many print statements. However this has severe drawbacks. Emulation typically distorts the program timing by an extremely large factor. Emulation requires interaction with many levels of software, including the operating system. Successful emulation often requires intense effort and skill by the operator, particularly for a large program, or a program in a complicated context. Also, emulation may lead to additional errors, and these complicate diagnosis of the original bug.

However, all the known software-based debugging systems fail to allow the developer to collect sufficient data, and at a sufficiently deep level, to efficiently locate and fix bugs. Another approach to debugging has relied on hardware-level troubleshooting. Hardware troubleshooters are able to collect huge amounts of evidence data, but lack the flexibility to flexibly focus the data collection. Therefore, the developer may be able to collect a huge evidence file, but then has the monumental task of trying to sort through the evidence to find any information useful to locate and fix the bug.

There are several known hardware-level troubleshooters. For example, U.S. Pat. No. 6,668,339 discloses a microprocessor that has a debug mode and a JTAG channel. Inside the CPU core, there is a vector switching circuit that can switch between execution mode and debug mode. The debug mode uses the JTAG channel to transmit out a small bandwidth of data from inside the microprocessor. External hardware, such an emulator interface works, and the JTAG channel are used to control the vector switching circuit and the debug mode. In another example, U.S. Pat. No. 6,516,428 has an on-chip debug system that includes a data band selector operable to transmit to an external emulator the selected data bands generated by selected components in the integrated circuit. The data band selector is directed by the emulator based upon instructions received from a host computer. In another example, U.S. Pat. No. 6,134,676 implements a hardware event monitor of control registers, and has programmable generic fields. These can be programmed internally or externally, to initiate successive compares with processing events. When all these criteria are fulfilled, this monitor can trigger external actions. The hardware event monitor and system trace controls act as a single unified entity. This entity can be remotely programmed over a UBUS. And as a final example, U.S. Pat. No. 5,295,260 provides an apparatus for monitoring access by a processor to certain defined portions of memory. The user specifies an address or range to be monitored, and each processor contains hardware which monitors outgoing memory references. This can be used in conjunction with debugging software packages. Suppose a processor executed an erroneous instruction, and improperly wrote to a memory address. This can pinpoint the error within a few instructions. This apparatus operates wholly independently and in parallel with the processor, and does not adversely impact system performance.

### BRIEF SUMMARY OF THE INVENTION

Briefly, the software debugging system starts with a processor that is executing a software process, and the software process has a bug or other failure. A fast-response reporter circuit connects to a low level asset in the processor, such as a reorder buffer, commit buffer, or high speed data path. The fast response reporter circuit is configured to selectively extract data from the low-level asset, and the extracted data is transmitted to an evidence file for review and analysis. In one arrangement, a fast-response sentry circuit also connects to a low-level asset in the processor, and is configured to monitor for a predefined event. When the predefined event occurs, the fast-response sentry circuit causes an action to occur, such as activation of the reporter fast-response circuit.

In a specific implementation of the debugging system, a fast response sentry circuit monitors a low-level asset in the processor for a predetermined software event, and upon that event, triggers a fast response reporter circuit to selectively extract data from the low-level asset. The sentry circuit and the reporter circuit each couple to sequential logic circuits, which enable more sophisticated and compound monitoring and selection. Once the data has been extracted, the data is stored in an evidence file for review and analysis. Using these means for and process of monitoring, selection, and extraction process, a user is able to efficiently focus on hypothetical areas of interest, as well as concentrate data collection on promising areas. A preparation software tool may be used to assist in configuring and setting up the reporter and the sentry. The debugging system also has tools to assist in examining the extracted evidence file. For example, an automated detective software may simplify the process of searching the evidence file for relevant evidence data.

In a particular construction of the debugging system, the fast logic circuits are integrated on-chip with the processor, thereby enabling efficient connection to the low-level assets, and causing only slight interference with the program executing on the processor. Further, the sequential logic may also be integrated on-chip as a co-processor or a thread in a multi-threading processor. The debugging system may also be constructed to take advantage of many resources available on the processor, such as controllers, cache memories, and data paths. By sharing existing resources, the debugging system may be more readily incorporated into existing chip architectures.

In using the debugging system, the user develops a general hypothesis as to the cause of a bug. Using preparation software, the user defines landmarks, codemarks, or other software events that may assist in locating the cause of the bug, and sets selection criteria to extract a useful quantity of evidence data. The user executes the software program, and collects selected data in an evidence file responsive to the sentry circuit detecting the software event. Using examination tools, the user reviews and analyses the evidence file, and gains insight into the location or cause of the bug. The queries developed in using the examination tools are useful in constructing the next landmarks for the sentry circuit and for the selection criteria for the reporter circuit. The user iteratively configures the debugger, collects new data, evaluates the data, and develops a more focused and concentrated hypothesis. Thus, the debugging system enables a systematic and more predictable methodology for debugging software failures.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a block diagram of a debugging system in accordance with the present invention;

FIG. 2 is an illustration of a debugging process in accordance with the present invention;

FIG. 3 is a flowchart of a debugging process in accordance with the present invention;

FIG. 4 is a block diagram of a debugging system in accordance with the present invention;

FIG. 5 is a block diagram of a processor coupled to fast-response sentry circuitry in accordance with the present invention;

FIG. 6 is a block diagram of a processor coupled to fast-response reporting circuitry and optional fast-response sentry circuitry in accordance with the present invention;

FIG. 7 is a flowchart of a debugging process in accordance with the present invention; and

FIG. 8 is a block diagram of a debugging process using an evidence file in accordance with the present invention.

### DETAILED DESCRIPTION OF THE INVENTION

Detailed descriptions of the embodiments of the invention are provided herein. It is to be understood, however, that the present invention may be embodied in various forms. Therefore, the specific details disclosed herein are not to be interpreted as limiting, but rather as a representative basis for teaching one skilled in the art how to employ the present invention in virtually any detailed system, structure, or manner. It will also be understood that connections or couplings may include intervening structures or processes.

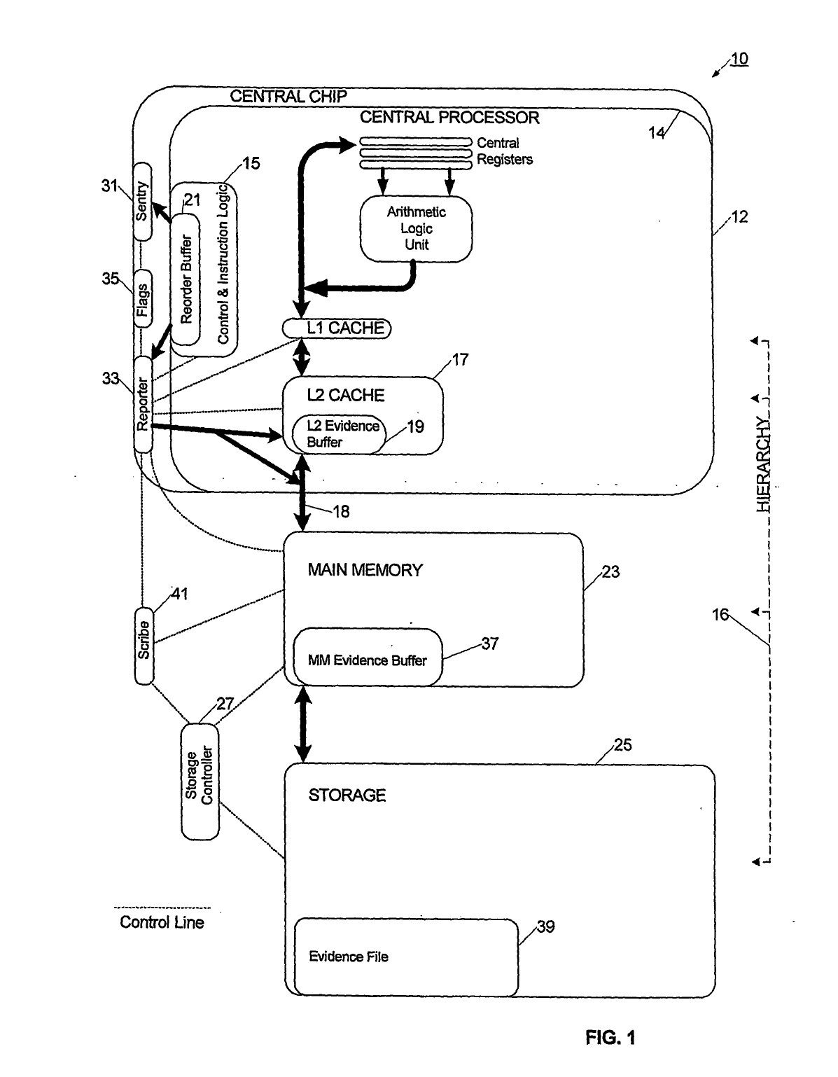

Referring now to FIG. 1, a debugging system 10 is illustrated. Debugging system 10 is implemented on a processor chip 12, and includes a central processor 14 for executing computer software processes. One of these processes may be a computer program that fails operation due to a software bug. The debugging system 10 is useful in locating and fixing the bug in the failing program. Although a standard computer processor i s shown, it will be understood that other integrated processing structures may be used. The processor has several internal low-level assets or deep-level resources, such as data busses, buffers, and registers, that cooperate in executing the software process. Several of these resources already exist in known processors, and may be used advantageously by the new debugging system. For example, the processor 14 includes a memory and storage hierarchy 16, and the necessary circuitry and controllers to manage transfers between hierarchy levels. The memory hierarchy 16 includes cache memory, including an L2 cache 17. This L2 cache connects to a main memory 23 through a high-speed data bus 18. By reusing these resources, either as they exist or with some modification, the debugging system 10 may be more readily incorporated into existing processor designs, and may operate with less interference to a program operating in the central processor.

The central processor 14 also has control and instruction logic 15 which includes a reorder buffer 21. The reorder buffer 21 holds detailed description information regarding the operation of a program operating on the central processor. It will be appreciated that other processor architectures will have other low-level assets that may provide analogous detailed descriptions. When the failing program is executed on the central processor 14, the reorder buffer 21 holds detailed information regarding variables, branching, and other execution details. In order to use this valuable information, the reorder buffer 21 connects to a sentry circuit 31 and a reporter circuit 31. Both the sentry circuit 31 and the reporter circuit 33 are constructed on-chip from fast-response circuitry, so are able to operate at or near the full processor speed. In one example, the sentry and reporter circuits include high-speed registers and comparators. However, it will be appreciated that other circuits may be used to implement such fast-response circuitry.

The sentry circuit 31 may be configured to monitor the data received from the reorder buffer 21 for a predefined software event. Then, during execution of the failing program, the sentry circuit 31 monitors the buffer data for a software event based on a data value, data address, instruction address, instruction code, or destination I-address. When the sentry 31 detects the target event, the sentry 31 may cause a corresponding action to be performed. In one example, the sentry 31 may set a flag 35 responsive to a particular predefined software event. It will be understood that the sentry circuit may take other actions, or may monitor data from a different low-level asset.

Responsive to a flag or other trigger signal set by the sentry 31, the reporter 33 extracts selected data from the reorder buffer 21. The reporter 33 has been configured according to predefined selection criteria. For example, the reporter 33 may be configured to extract only the data values related to a particular range of data addresses. In this way, the reporter 33 rejects all other data, and generates an evidence file focused on the progression of a particular target variable. In other examples, the reporter 33 may focus on particular addresses, branches, or time periods. It will be appreciated that the reporter 33 may be flexibly configured to apply data focus according to many particular debugging needs. Further, although the sentry and the reporter use criteria that have been predefined, it will be understood that the sentry and the reporter may be flexibly configured prior to execution, and may even be reconfigurable during execution.

As the reporter 33 extracts data from the reorder buffer 21, the reporter 33 sends the extracted data to an evidence buffer 19 in L2 cache. Advantageously, the reporter 33 uses the existing high-speed data bus 18 in the transfer. In this way, the reporter 33 is able to load the evidence buffer 19 with little interference to the program operating on the central processor, and at a speed sufficient to capture the desired level of data detail. The L2 cache is a limited resource shared between the debugging process and the program operating on the central processor. Accordingly, the evidence buffer 19 needs to be flushed occasionally to a larger memory or storage location. This task is managed and monitored by a scribe process 41. The scribe 41 assists the reporter 33 in moving data in the evidence buffer from L2 cache to the main memory 23. In this way, the scribe 41 maintains and manages the flow of evidence data as it moves from an evidence buffer 19 in the L2 cache 17, to an evidence buffer 37 in the main memory 23, and to an evidence file 39 in external storage 25. The scribe 41 may use existing resources, such as the storage controller 27, to accomplish the data transfers. In this way, the implementation of the scribe and management of the data transfers are simplified.

The debugging system 10 thereby enables the collection of evidence data at a deep level in the processor. The data may be collected with only a small amount of overhead to the processor, and therefore the data may be collected at or near the operational speed of the processor. Further, the collected data may be selected to focus and concentrate the evidence data on a particular target of interest. The sentry 31 and reporter 33 will typically be constructed on-chip and integrated with the processor to enable the most efficient collection of evidence with the least impact on processor performance. However, it will be appreciated that these functions may be constructed in other arrangements.

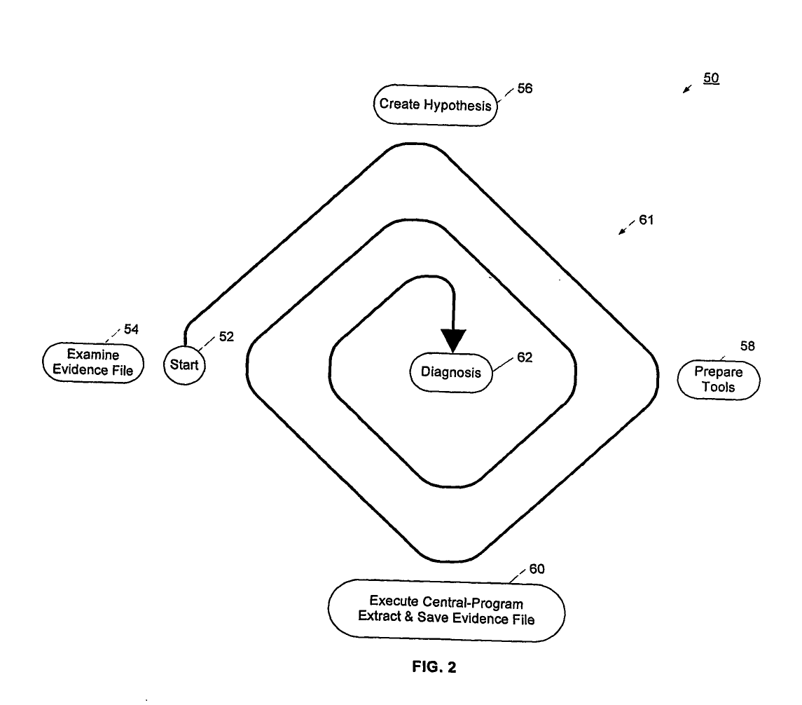

Referring now to FIG. 2, a debugging process 50 is symbolically illustrated. The process 50 is useful for a software developer to locate and fix a bug in a failing software program. At the start 52, the software developer examines evidence 54 of the software failure. This evidence may be an evidence file generated by a debugging as generally described with reference to FIG. 1. After reviewing the evidence 54, the developer creates a hypothesis 56. Based on the hypothesis 56, the developer prepares 58 (aims, programs) tools in the debugging system to monitor the processor and to selectively extract data. The failing program is then executed 60. During execution, the tools selectively extract and store new evidence 60 into a new evidence file. The sequence is iterated: the developer evaluates the new evidence file; modifies the hypothesis; again prepares the tools; and again executes the failing program. As the developer performs these iterations, the developer is using new evidence to more narrowly focus and concentrate the next iteration. In this way, the developer systematically and methodically spirals 61 to the cause and diagnosis 62 of the bug. In many cases, this process 50 enables efficient and systematic convergence: from crude evidence and a crude hypothesis; through better evidence and better hypothesis; to clear evidence and clear diagnosis of the bug.

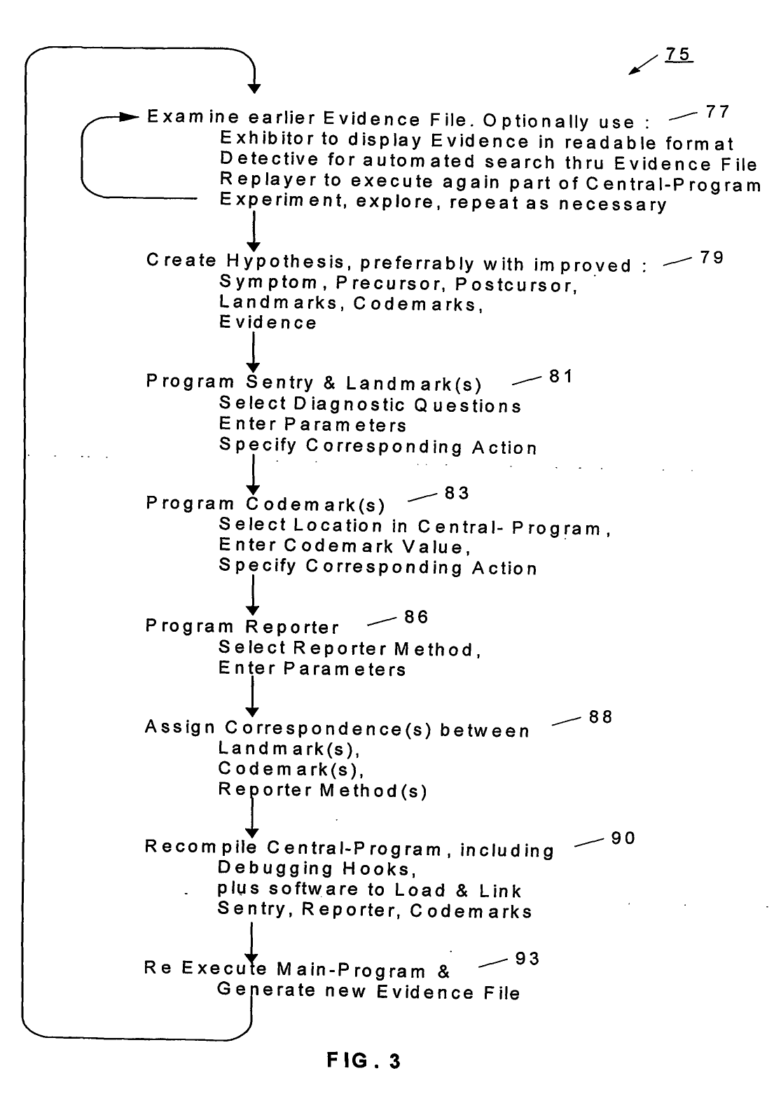

Referring now to FIG. 3, a debugging process 75 is illustrated. The process is useful for a software developer to locate and fix a bug in a failing software program. The debugging process 75 starts with a software developer examining an evidence file as shown in block 77. The evidence file contains data extracted from a low-level asset of a processor while a failing program was being executed. In this way, the evidence file may contain data useful to locate the cause of the program's failure. The developer then creates a hypothesis for the bug as shown in block 79. This hypothesis may address the symptom of the bug, a precursor to the bug, or a post-cursor to the bug. As shown in block 81, the developer configures or programs a sentry circuit to monitor for landmarks or other software events, and to set the corresponding action the sentry will take when the landmark occurs. The developer may use off-line preparation software to assist in configuring the sentry, with the preparation software providing a user-friendly interface, menu, or wizard. The developer may also place codemarks in the failing program, as shown in block 83. Upon execution, these codemarks are useful to identify when particular code sections execute, and to more closely focus data extraction. The developer also configures or programs the reporter to extract the desired level of data evidence, as shown in block 86. The developer may assign reporter methods that are to be performed responsive to the landmarks, codemarks, or other software events. In this way, a particular landmark or codemark may result in a different selection criteria for the reporter. The developer may also use preparation software to assist in configuring the reporter, with the preparation software providing a user-friendly interface, menu, or wizard. Typically, the software developer and preparation software introduce small modifications in the central-program source-code to load and link the programs for the sentry, reporter and codemarks. Also, recompilation enables adding source-code names as comments in the instruction stream, and provides address tables to help understand these instructions. Therefore the developer may need to recompile the program as shown in block 90. The developer then executes the failing program on the processor to generate a new evidence file as shown in block 93. The developer repeats the sequence using the new evidence file, and sets new and more focused landmarks and selection criteria. As the developer performs these iterations, the developer is using new evidence to more narrowly focus and concentrate the next iteration. In this way, the developer may systematically and methodically locate the bug.

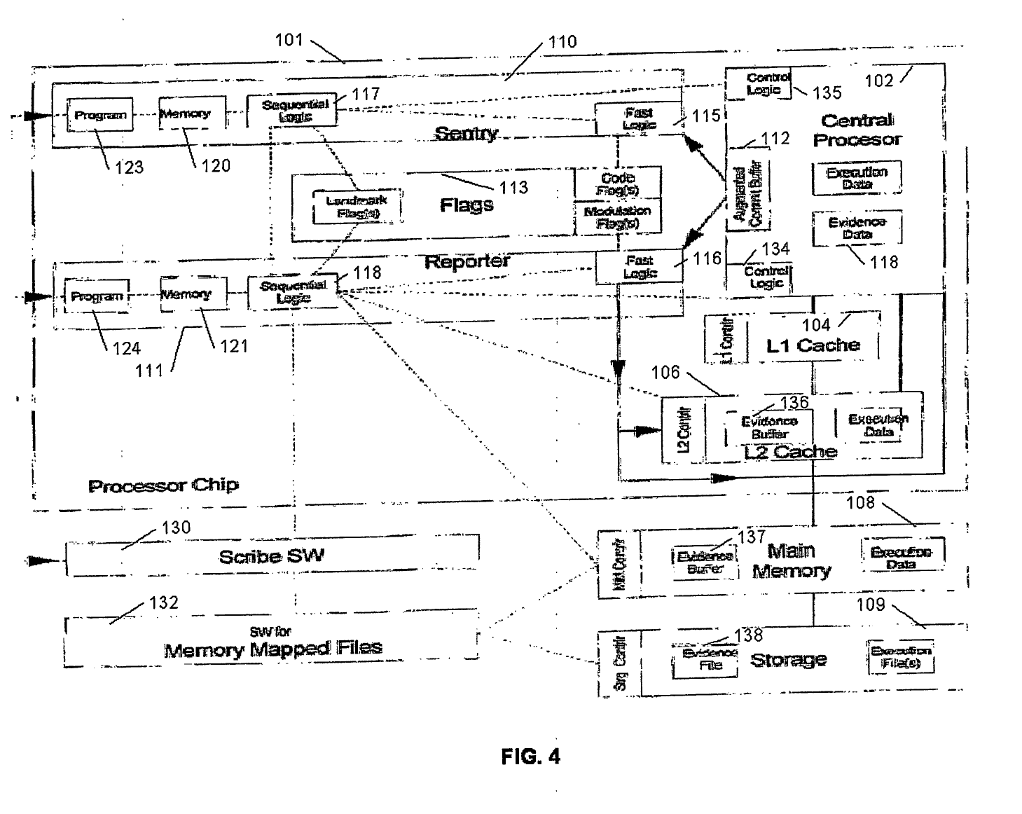

Referring now to FIG. 4, a debugging system 100 is illustrated. The debugging system 100 may be used by a software developer or other user to systematically locate the cause of software failures. Suppose the user has a central-program that can execute on a computer but fails to operate correctly. The failure includes at least one symptom that is known to the user, which indicates a bug (error) in the central-program. The user needs to diagnose this bug. For this task, the debugger 100 uses a systematic method and associated tools, particularly tools closely coupled to the processor 101 of the computer. The debugger 100 provides several deep-level tools, which will be referred to as the “sentry” 110, “reporter” 111, “flags” 113, as well as an evidence buffer 136 in L2 cache 106. Further outboard or off-chip, this debugging system also has an evidence buffer 137 in main-memory 108, and an evidence file 138 in Storage 109.

The tools and methods will be first generally defined, and then selected aspects of the debugger 100 will be presented with greater detail. Generally, the sentry 110 detects specified events (landmarks), while the reporter 111 extracts and saves specified evidence. The evidence is saved temporarily in evidence buffers, and is later saved permanently in the evidence file. The deep-level tools are coupled closely to the processor. Some of these tools operate during execution of the central-program, with very little distortion of execution. In one example, the sentry and reporter each include a program 123/124, a memory 120/121, sequential logic 117/118 (e.g.: co-processor) and fast logic 115/116 (e.g.: register and gate logic). In one application of the debugger 100, the central processor 102 includes an augmented reorder buffer 112. When a statement is executed, the augmented reorder buffer 112 provides a detailed description of the statement and associated data.

The detailed description feeds through a deep-level high-speed data path to the sentry fast logic, which comprises comparators and registers to detect a specified landmark(s). When detected, the fast logic may trigger the sentry sequential logic to take specified corresponding action. The detailed description also feeds the reporter fast logic. In some cases, some of the detailed description is extracted and saved as evidence.

Flags may be used to assist in gathering and saving evidence during execution. Flags include, for example, a landmark flag(s), a code flag(s), and a modulation flag(s). When the sentry detects a landmark, it sets the landmark flag(s). This steers the reporter to the relevant reporter method. The modulation flag(s) directly modulates extracting and saving evidence. During execution of the central-program, an optional statement can specify a codemark. When the codemark executes, the sentry sets a corresponding code flag, and modifies one or more modulation Flags.

The evidence buffers and evidence file may be implemented with general purpose resources already available for use on the processor chip or on associated off-chip circuitry. The general purpose resources include, for example: memory space allocations in L2 cache, main memory, and storage; automated means to transfer data between L1 cache, L2 cache, main memory, storage; and time/priority allocations. For functions beyond the processor chip, the debugger 100 provides several software tools, which will be refer to as the “scribe software” 130, the “exhibitor software”, the “detective software”, and the “preparation software”. In one example, all these software tools operate in the original computer.

After the sentry and reporter have been configured, the central-program is executed on the computer. During execution, the central-processor provides a detailed description of execution. The sentry tests the data in the detailed description, and detects if and when a specified landmark event occurs, and takes specified corresponding action. Typically, the action sets a landmark-flag to indicate occurrence of the landmark, and activates the reporter. In some cases, the action may include additional tests to sharpen the definition of a landmark. During execution, the reporter extracts and stores evidence. This process and resulting evidence are guided by the specifications (program) for the reporter, and also are modulated by the flags for landmarks and codemarks. Thus evidence is extracted selectively. Also, evidence is saved into an evidence buffer in L2 cache, into an evidence buffer in main-memory, and into an evidence file in storage.

For more efficient implementation, the debugger 100 may take advantage of many resources already included in the computer. For example, the computer has a memory hierarchy (L1 cache, L2 cache, main-memory), plus data paths and automatic means to transfer data between levels of this memory hierarchy. Also the computer has storage, plus data paths and automatic means to transfer data between the memory hierarchy and storage. The debugger 100 also takes advantage of these resources to transfer evidence from an evidence buffer in the L2 cache to a larger evidence buffer in main-memory, and then to an evidence file in storage. With the debugger 100 generally introduced, examples of use will first be describer, and the selected tools and methods will be discussed in more detail.

### EXAMPLES

This section teaches several examples that introduce and illustrate the usage, functions and structures of the debugging system.

### Example A: Landmarks

Earlier Evidence and Hypothesis: Suppose the operator examines earlier evidence. This shows a specific variable with two different values. During earlier execution, this variable has a correct value. During later execution, this variable has an incorrect value. Therefore the operator creates (envisions) the following crude hypothesis:
There is a Precursor: Assignment of the correct value to this variable.
There is a Symptom: Assignment of the incorrect value to this variable.
There is a Bug: During Execution, the Bug occurs between the Precursor and Symptom.
The following evidence may provide clarification: Evidence of Execution between the Precursor and Symptom.

The hypothesis concerning the Bug is quite crude. Nevertheless, often this will lead to eventual diagnosis. Therefore the operator creates (envisions) the following pseudo-code:
{Landmark: Precursor} A specific (correct) value was assigned to a specific variable.
{Corresponding Action} When this landmark occurs, then take the following corresponding action. First, pause execution and assign a value to the landmark flag. Second, extract and save some data as evidence. Third, resume execution and steadily extract and save a stream of data as evidence.
{Landmark: Symptom} A specific (incorrect) value was assigned to a specific variable.
{Corresponding Action} When this landmark occurs, then take the following corresponding action. First, pause execution and assign a (different) value to the landmark flag. Second, flush from evidence buffers into the evidence file. Third, resume execution.

The debugging system provides a tool (preparation software) to help the operator in translating this pseudo-code into specifications and programs for the sentry and reporter. During execution, the central-processor provides the sentry with a detailed description of each instruction. These include the instruction op-code (verb), data address, data value, instruction address. The sentry has means to compare this detailed description with specified op-codes (verbs), addresses, data values. The sentry includes serial or sequential logic (example: a co-processor). When a landmark occurs, the sentry may execute a specified corresponding action. For example, the sentry may assign a value to a landmark flag and activate the reporter. Then the reporter tests the landmark flag and branches to the corresponding action. This invokes reporter methods to extract and save evidence. The sentry and reporter are supported with “deep-level resources”. In many cases, these are highly compatible with the central-program. These can operate almost simultaneously with execution of the central-program, without major time-distortions. The operator programs or configures the sentry to detect each landmark during execution. Whenever the instruction op-code (verb) is “write to memory”, the sentry compares the data address against a specified address, and compares the data value against a specified value. Also, the operator programs the sentry and reporter with corresponding action for each landmark. With these preparations, the central-program is again executed. This extracts and saves a new evidence file that corresponds to the above hypothesis. The operator can use the exhibitor and detective software tools to examine this evidence file. Thus the operator systematically and efficiently can extract and save evidence that relates to the following diagnostic questions: “During Execution of Central-Program, after occurrence of this Precursor, when did this Symptom occur? How and why did this Symptom occur?” This may be abbreviated as follows: “When, how and why did this Symptom occur?” To help the operator examine the evidence file, the detective provides efficient means to ask and answer a similar diagnostic question. Thus an operator can proceed from a precursor and symptom, to extract and save evidence that clarifies these. This debugging process can be iterated. Thus in many cases, an operator can efficiently and systematically extract and follow evidence from a symptom to the bug that caused it.

### Example B: Examination & Preparation

Above Example A illustrated how it is useful to detect when a specified address is assigned a specified value. Here Example B illustrates how to specify an address and to specify a value.

Address Types: Often, when a central-program is executed repeatedly, some or many addresses are the same across executions (“repeatable”) as a hexadecimal virtual address. In other cases, an address is better described (more repeatable or more understandable) in symbolic form similar to source-code. Either address style may be specified in the test for a landmark. To help the operator to examine an evidence file after execution of the central program, the debugging system provides exhibitor software and detective software. The exhibitor and detective support displaying an address as a hexadecimal virtual address, such as “0000 1B3F”. Also, the exhibitor and detective tools support displaying an address as source-code symbolic address and its context. Here context provides the definition or scope for this symbolic address. For example:
address “vector[12]”
at context “statement #23 in Method CalculateRoute( )”.

A software entity typically has a name, address, logical size. Each of these has a “scope” in the program where it is valid, and a scope during execution when it is valid. The context is a statement where and when all three are valid. In some cases, this immediately follows the statement that creates or defines the entity. In some cases, such as the source-code language “Java”, the context should be a stack of entities. Suppose, class A has local object Vab of class B. Suppose class B has a local object Vbc of class C. Suppose class C has local object Vcd of class D. In Java source-code, the expression “Vab.Vbc.Vcd” describes variable Vcd that has context Vbc that has context Vab.) The operator prepares (aims, configures, programs) the sentry and reporter for a subsequent execution of the central-program. To help this preparation, this invention provides a tool, the preparation software. This provides a menu of landmark definitions and sub-definitions for the Sentry.

Here are some examples:

Specify type of Landmark:
“Detect specified D-address”
“Detect specified D-address and specified D-value”
“Detect specified I-address for executed instruction”
“Detect specified I-address for rejected destination of branch-family instruction”
Specify op-code (verb) for Landmark:
“Do not specify op-code”
“Detect writing”
“Detect reading”
“Detect branch-family instruction”

Specify address for Landmark:
“Specify exact address” then { } “Enter one address”
“Specify range of addresses” then { } “Enter two addresses”
“Specify address in hexadecimal form” then { } “Enter hexadecimal address”
“Specify address as source-code symbolic expression” then { } “Enter expression”
“Specify source-code context for symbolic address” then { } “Enter context”

Specify value for Landmark:
“Do not specify value”
“Specify exact value” then { } “Enter value”
“Specify upper value” then { } “Enter value”
“Specify lower value” then { } “Enter value”
“Specify range of values” then { } “Enter two values”
“Specify set of excluded values” then { } “Enter one or more values”
“Specify ranges of excluded values” then { } “Enter pairs of values”

Thus the operator can determine and specify the address and value for a landmark. The above provides considerable power and flexibility, with good usability for a less-specialized software developer. Free-form programming can be avoided by a less-specialized operator, but used by a more-specialized Expert.

In a similar style, the preparation software enables the operator to specify how to respond to a Landmark:
Corresponding Action for the Sentry.
Corresponding Methods for the Reporter.

The debugging system may support various types of landmarks. Preferably this support includes: exhibitor software and detective software features to display relevant parameters; preparation software features to specify relevant parameters; and sentry features to detect the landmark during execution. This example illustrates the interplay between examination and preparation. Thus examination of earlier evidence systematically enables preparation for later evidence that is better aimed and focused.

### Example C: Codemarks

Scenario: In example A above, the operator knows a clear-cut and distinctive symptom in the earlier evidence. By contrast, in Example B, the earlier evidence reveals merely there is an error during somewhere between two events during execution. The earlier event will be called the precursor, and the later event will be called the postcursor. Suppose the earlier evidence does not provide a known, clear-cut, distinctive symptom. Suppose there is extensive execution between the precursor and postcursor. It would be overwhelming to extract, save and examine evidence that completely described so much execution between the precursor and postcursor. Suppose The central-program includes new software, which is not well-established, and also includes mature software, which is well-established and believed to be free of errors (such as library methods). During execution between the precursor and postcursor, most execution time and details may involve the mature software, and much less involve the new software. For example, the new software may be a brief new function that invokes the mature software for detailed calculations. Accordingly, the operator hypothesizes the error probably is in the new software, and probably is not in the mature software. The operator needs a “high-level trace” that reveals execution of the new software only, and needs to avoid being overwhelmed by a “low-level trace” including too much of the mature software.

The operator can use codemarks to concentrate evidence on execution of some software, and to minimize evidence on execution of other software. For example, using preparation software, the operator can assign a codemark value to a central method in the central-program. As described below, a table lists the codemark of various central methods. When this central method executes, its codemark is loaded in the codemark central flag. In a similar manner, using preparation software, the operator can assign a codemark value to a reporter method. For example, another table lists the codemark of various reporter methods. When this central method executes, its codemark is loaded in the codemark reporter flag. When this reporter method executes, its codemark is compared with the codemark flag. When the codemark flag is larger or equal, then the reporter method is effective. When the central codemark is smaller, then the reporter method is suppressed.

The “handle” of a software entity is an execution-time value, such as a 64 bit integer, to identify this software entity during Execution. The debugging system may provide a table that lists handles for methods and corresponding codemark values. The preparation software enables the operator to fill in this table. This table is content-addressable, supported by deep-level resources. During execution, given a handle, this table will rapidly provide its codemark. Also the table may include a default codemark(s). Given any handle that is not explicitly included, this returns a default codemark. Alternatively, codemark values may be expressed by in-line statements.

More Advanced Example: Suppose the operator hypothesizes there are three categories of methods: (ii) new code that might contain a bug, where more detailed evidence is justified; (ii) new code that probably is less related to the bug, where less detailed evidence is justified; or (iii) mature code that probably is bug-free, where evidence is not justified. By using three values for codemarks, this selectivity can be readily achieved.

### Example D: Negative Symptoms

Earlier Evidence and Hypothesis: Suppose examination of earlier evidence does not reveal a clear and distinctive symptom, as described above in Example A. Instead, it reveals that some segments of the central-program did not execute, even though “they should have executed”. Let this be called a “negative symptom”. This makes it challenging to extract relevant evidence. Nevertheless, the debugging system teaches means and method that often efficiently resolve this challenge. To better understand this example, several terms will be defined below.

Branch-family instructions: These include any instruction that could change the execution sequence. For example, this includes: Jump; Unconditional Branch; Branch and Execute; Conditional Branch; Switch; Call; Call and Link; Interrupt; and Return.

Destination: A Branch-family instruction provides one or more I-address as possible addresses to execute next. Let these be called “destinations”. Some destinations are explicit in the instruction. Other destinations are implicit: the fall-through for a branch-family instruction; the return address for a Return instruction.

Rejected, Selected: A destination which is executed next is “selected” or “taken”. A destination which is NOT executed next is “rejected” or “not taken”.

Direction, To Peek: For an executed Branch-family instruction, its “direction” indicates which destination was selected, and which was rejected. Let “to peek around a branch” be understood “to observe the rejected destination(s) at a Branch-family instruction”. This invention teaches how peeking around a branch can help to diagnose certain bugs.

Method and Uses: In the following “Negative Symptoms”, let “Method” be understood to mean “any method, procedure or code-segment”. Also let the following phrase:
MethodR uses MethodS be understood to include several possibilities:
(MethodR calls MethodS) OR
(MethodR branches to MethodS) OR
(MethodR falls through to MethodS)

The operator creates (envisions) the following preliminary Hypothesis:
{Expected Execution} During Execution, the operator expects a sequence of Methods “should have executed”:
MethodA uses MethodB uses . . . MethodY uses MethodZ
{Observed Evidence} However Earlier Evidence reveals that MethodA executed but NOT MethodZ
{Bug} Execution started along this sequence, but did NOT complete this sequence.
Therefore, during Execution, some Branch-family instruction DIVERGED from this sequence.
{Better Evidence to Find Evidence of a Branch-family instruction that DIVERGED from this sequence.

This leads the operator to create (envision) the following pseudo-code:
The operator provides a list of instruction addresses that “should have executed”. During a relevant part of execution of the central-program, at every executed branch-family instruction, the following shall be extracted and saved as evidence: the I-address of this instruction; every destination I-address; and the direction of this branch
If necessary, sharpen the search. Find any branch-family instruction such that: its I-address follows this list; some rejected destination follows this list; and the selected destination does NOT follow this list.
Each rejected destination is compared with the list described above. If a match occurs, the then take corresponding action as specified by the operator. For example, this specifies what reporter method to use, and hence what further evidence to extract and save.

At an earlier stage, the detective discovers this in an evidence file. At a later stage, this defines a landmark which the sentry finds during execution. As in Example A, this illustrates how the debugging system provides systematic improvement leading to clearer evidence and clean diagnosis. Of course, the effectiveness of this example depends upon the list of I-addresses.

### Example E: Concentration of Evidence

Landmarks enable selection WHEN during execution to gather evidence. Codemarks enable selection WHERE in a program to gather evidence. In many cases, these two are logically quite distinct, and both can be used during the same execution. Together these can be used to greatly concentrates Evidence.

### Example F: Landmarks for Sustained Reporter Methods

Suppose the operator knows a distinct and clear-cut symptom, and hence has defined a landmark. During execution, this landmark will occur after the bug has occurred. By contrast, some reporter methods are “sustained”. To gather and save relevant evidence, these reporter methods are to be started before the Bug. Therefore the symptom landmark is not useful to trigger these Reporter methods. Therefore the operator may construct a precursor landmark, that occurs before the bug. This is useful to trigger sustained reporter methods. The symptom landmark is useful to terminate sustained reporter methods.

Sentry

In the art of debugging software, a frequent problem is “to find a needle in a haystack”. In other words, there may be a large set of items (possibilities, evidence), and it can be daunting to find the relevant item. To more systematically identify bugs, the debugging system uses the sentry and landmarks. These provide an automated means to detect and respond to a specified event during execution. In many cases, this can efficiently detect a rare event in spite of very many instructions executing rapidly. In many cases, the debugger enables extracting and saving failure evidence that closely corresponds to a failure hypothesis. The debugging system may be constructed where the sentry and central-processor are distinct. In other arrangements, these are more closely integrated. The sentry and central-processor may be constructed on the same chip. The sentry typically includes: sentry fast logic; sentry data registers or very fast memory; sentry sequential logic; and sentry memory for instructions. It will be appreciated that other components or structures may be substituted.

The processor typically includes a time-clock. The clock may measure instructions, processor cycles, physical seconds, or other chronological units. It may measure time from an arbitrary origin or a meaningful origin. A reading from the time-clock is called a time-stamp. The main process may also include a commit or reorder buffer. As each instruction completes execution, the reorder buffer provides a detailed description of the instruction and its direct results. The detailed description may be augmented with a time-stamp and an I-address of the current instruction (i.e.: the address in the program counter).

Each branch-family instruction offers one or more destination I-addresses. An unconditional branch offers one. A classical conditional branch offers two: an explicit out-of-line address, and a fall-thru in-line address. An N-way switch instruction offers N-destinations, including a fall-thru in-line address. A branch selects (“take”) one of these destinations, and rejects (“does not take”) all others. Second, for each branch-family instruction, the detailed description is further augmented with the number of destinations; every destination I-address offered by this branch instruction; and the branch direction (i.e.: which destination was selected).

There is a data path from the central-processor reorder buffer to the sentry fast logic. As each instruction completes execution, the augmented detailed description is fed through this to the sentry fast logic. The sentry fast logic supports functions that are executed very often, particularly testing for landmarks. This has means to compare the current description parameters (as above) against specified values, and has means to hold specified values. This has means to support various types of comparison, such as: equality, one-sided, two-sided, Boolean combination of one or more comparisons. (Let “CDA”, “CDV”, “COpC” be abbreviations for “Current Data-Address” and “Current Data-Value” and “Current Operation Code”.) As an example, sentry pipeline logic efficiently supports the following Landmark:

Landmark=(COpC equals “Memory Write”) AND (CDA in specified address-range) AND (CDV in specified value-range).

When a landmark is detected, the sentry does a corresponding action. The sentry fast logic may support extremely simple corresponding action. For example, this can assign a specified value to a landmark flag or activate the sentry sequential logic. However, further more complex corresponding action is supported by sentry sequential logic.

In one example, the sentry fast logic is implemented as a logic pipeline using registers, comparators and gates. There are registers to hold current and specified information. Between these registers, there are comparators. Between comparators, there are gates for Boolean combinations of comparisons. There are auxiliary gates to steer information and to reconfigure the sentry fast logic. Sentry fast logic may also support many fast tests that are useful for landmarks. The Sentry fast logic supports functions that are executed frequently. Much less frequently, this detects a landmark, and activates the sentry sequential logic. This reduced frequency mitigates the less fast speed of sentry sequential logic.

The sentry sequential logic provides great versatility for functions that occur less frequently and at slower operational speed. The sentry sequential logic thereby supports corresponding actions of greater complexity then the fast logic circuit. For a complex landmark, the sentry sequential logic provides additional testing. This may be useful to augment the sentry pipeline logic. In a first example, a landmark is defined by a memory write instruction to a specified row of a specified matrix. A second example is a landmark defined by smaller events occurring in a specified sequence. This could be useful to diagnose a bug concerning execution sequence.

Sequential logic supports loading or storing data between sentry registers and the memory hierarchy, and supports interaction with methods in the central-program. For example, this supports: testing data in the memory hierarchy; assigning specified values to sentry registers; and loading a sentry program into sentry memory from the memory hierarchy. In one construction, the sentry sequential logic includes a tiny and fast co-processor, which resembles a very small Digital Signal Processor (DSP).

The debugging system has a memory for sentry data and sentry instructions. (SRAM and DRAM shall be understood as “Static Random Access Memory” and “Dynamic Random Access Memory”.) In one example, the data memory is a small array of SRAM or possibly very fast embedded DRAM. During setup and preparation of the debugging system, the operator uses software tools to construct sentry programs to guide sentry pipeline logic and sentry sequential logic. These programs may specify each landmark test and its corresponding action. Specified addresses may be represented numerically or symbolically (i.e.: in a style similar source-code for the central-program).

The setup or preparation software may provide a linker and loader for the sentry programs. Sentry programs may be transferred through the memory hierarchy. Before and during execution of the central-program, sentry programs are transferred into sentry memory. Before and during execution of the central-program, memory is allocated, and addresses are assigned to software elements of the central-program. Then these addresses are loaded into the sentry memory, to serve as specified addresses. In some cases, it may be useful to augment the sentry functions by instructions to the central-program. This is more attractive if the central-processor supports near-simultaneous execution of plural threads of instructions. This offers versatility and convenience. In particular, this enables the operator to use high-level language source-code to augment detecting a landmark and taking corresponding action. However, this may significantly time-distort execution, and hence degrade compatibility with the central-program.

The processor chip may also include registers to hold flags, particularly the landmark flag and the codemark flag and modulation flag. The landmark flag drives a switch statement in the sentry sequential logic. The codemark drives some reporter methods, and thus modulates extraction of evidence. Other arrangements may provide additional or different flags. One first example is a stack of codemark flags that is analogous to call stack. A second example provides more landmark flags to enable control of how their effects overlap. A third example adds other flags for more versatile modulation of evidence.

Constructing the sentry circuit on-chip may depend on the engineering and development schedule for the processor chip. If the central-processor is already designed, then a separated arrangement may be used, although it may not function as well as the on-chip construction. If the central-processor is in an earlier design phase, then the more integrated arrangement is preferred. In one example, the sentry fast logic is very closely adjacent or merged with a low-level asset in the central-processor, for example the reorder buffer. This may enable lower power dissipation, particularly in the data-path for the detailed description, and in sentry fast logic. Some emerging central-processors support almost simultaneous execution of plural threads of instructions. In these processors, an additional thread on the central-processor may take the place of the sequential logic. Other emerging processor chips include plural processors. In these processors, one processor may serve as central-processor, and another supports sequential logic for the sentry and reporter. In a similar manner, the flags and central-processor may be separated, very closely adjacent, or merged with the central-processor. Also in a similar manner, the reporter and central-processor may be separated, very closely adjacent or merged.

Reporter

During execution, the reporter can extract evidence and save it to the L2 cache, main memory, or storage. More completely, the reporter supports the following functions: (i) the operator may program or configure the reporter; (ii) the sentry may activate the reporter; and (iii) the reporter may provide for reporter methods. For some reporter methods, during execution, the reporter methods extract and save evidence to L2 cache or main memory. These reporter methods are deep-level resources. Some reporter methods may save evidence to a file in storage. Reporter methods may be arranged to use both deep-level and software-level resources.

The operator may use software tools to program an optional reporter method. This method may use software-level resources to extract and save evidence during execution. The reporter supports several types of reporter methods: pre-defined one-shot reporter methods; pre-defined sustained block-oriented reporter methods; pre-defined sustained instruction-oriented reporter methods; and user-programmed reporter methods. In one example, the reporter includes: reporter sequential logic, reporter memory, reporter data paths, reporter gates, reporter flags, and auxiliary logic to drive these gates and flags. The sequential logic interacts with controllers for L1 cache, L2 cache, main memory and storage. Also the sequential logic drives the reporter gate(s). The computer system already has data busses between the central-processor and L1 cache, L2 cache, main memory and storage. The reporter adds data paths and gates between the augmented reorder buffer and L2 cache, and main memory. In a one example, the reporter sequential logic and reporter memory resemble a very small simple Digital Signal Processor and its instruction memory.

In one arrangement, pre-defined reporter methods build upon and correspond closely to resources and internal engineering already included in the computer system. This facilitates pre-defined reporter methods which are highly compatible with the central-program executing on the central-processor. In many cases, such reporter methods and the central-program can both execute almost simultaneously, with modest or small time-distortion and unchanged results by the central-program. It will be understood that different processor architectures and implementations will lead to different reporter methods and programs.

The reporter may provide pre-defined single-short reporter methods, such as the examples below. When such a reporter method is invoked, it extracts and saves a specified finite block of data to evidence. Such a reporter method includes a procedure (program) for the reporter sequential logic. This drives the controller for L2 cache, and/or the controller for main memory, and/or software to operate storage, particularly software for a memory mapped file. These reporter methods may be implemented as deep-level resources, augmented by system software to operate a file in storage. In many cases, these reporter methods operate very compatibly with execution of the central-program. Examples of several reporter methods follow.

{Copy Execution Main Memory to the Evidence File} (In a relevant computer system, some storage controller functions are provided by software in the operating system. In particular, this typically provides “MMF”, a Memory Mapped File. This uses a range in Main Memory as a door to write data to storage.) Thus this reporter method directly copies all of main memory to an evidence file. This reporter method interrupts then later resumes execution of the central-program. By contrast, most other reporter methods are much more compatible with execution.

{Copy Application Data Sectors from Execution Main Memory to the Evidence File} This reporter method resembles the above reporter method, but this is restricted to main memory sectors with a security code for application data. Also, this reporter method interrupts and later resumes execution of the central-program.

{Copy Execution L2 Cache to Evidence} Copy every page from the execution L2 cache to the evidence buffer in main memory, and/or to the evidence file in storage. This may take advantage of resources in the memory hierarchy, and resources for storage and files. Thus dumping evidence into main memory is a deep-level resource.

{Copy a Page from Execution L2 Cache to Evidence} This reporter method uses the memory controllers to copy a specified page from L2 cache to an evidence buffer main memory and/or to an evidence file in storage.

{Copy Execution L1 Cache to Evidence} Copy every line from execution L1 cache to the evidence buffer in L2 cache, and/or to the evidence buffer in main memory. This method may take advantage of resources in the memory hierarchy, and this is a deep-level resource.

{Copy a Line from Execution L1 Cache to Evidence} When a line is written from execution L1 cache to execution L2 cache, it is also written to the evidence buffer in L2 cache, and/or is written to the evidence buffer in main memory. This method takes advantage of resources in the memory hierarchy, and thus is a deep-level resource.

{Copy a specified virtual-address range from Execution to Evidence} Depending on the size of this range, and its physical address in the memory hierarchy, execution data from this range is copied to the evidence buffer in L2 cache, and/or to the evidence buffer in main memory, and/or to the evidence file in storage. This may take advantage of resources in the memory hierarchy, and resources for storage and files. For copying evidence to L2 cache or main memory, this is a deep-level resource.

{Copy the Call Stack to Evidence} This reporter method uses the pointer to the origin of the call stack, and uses the pointer to the next unused address on the call stack. Together these specify a virtual-address range that is used with the previous reporter method, and copies all the call stack to an evidence buffer in the memory hierarchy. This reporter method is a deep-level resource insofar as the evidence is saved to L2 cache or main memory. However, insofar as this saves to the evidence file in storage, this also uses software to operate a memory mapped file.

{Copy a specified Call Vector from the Call Stack to Evidence} This reporter method uses the list of pointers to the call stack. This reporter method uses two successive pointers to define a range of addresses. Use this range and a preceding reporter method, this copies a call vector to evidence. In some cases, this is largely a deep-level resource.

The reporter may also provide pre-defined sustained block-oriented reporter methods, such as defined below. When such an reporter method is invoked, this flushes a buffer, then copies a block from execution to evidence. This is repeated for new blocks, until this reporter method is halted. Such a reporter method includes a procedure that operates on the reporter sequential logic. This interacts with the controllers of the memory hierarchy described above. Suppose a block is transferred down in this hierarchy. Almost simultaneously, the reporter method procedure uses these controllers, to transfer also a copy into evidence at a similar or lower level. Examples of such reporter methods follow.

{Repeatedly copy an Execution Page from L2 Cache to Evidence} When necessary, the memory hierarchy automatically writes a page from execution L2 cache to execution main memory. This reporter method uses the memory controllers, and almost simultaneously copies this page to the evidence buffer in main memory, and/or to an evidence file in storage. This method has several important virtues. This method does not increase the data rate load between the L2 cache and main memory. For copies to main memory, this reporter method is a deep-level resource. In many cases, this reporter method is highly compatible with execution of the central-program. In some cases, this reporter method extracts and saves evidence that is useful for diagnosis.

{Repeatedly copy a Line from Execution L1 Cache to Evidence} When a line is written from execution L1 cache to execution L2 cache, then this reporter method copies this to the evidence buffer in L2 cache, and/or to the evidence buffer in main memory. This method takes advantage of resources in the memory hierarchy, and thus is a deep-level resource.

{Repeatedly copy the latest Call Vector from the Call Stack to Evidence} This reporter method uses the list of pointers to the call stack. This reporter method uses the last two pointers to define a range of addresses. Use this range and a preceding reporter method, this copies a call vector to evidence. In some cases, this is largely a deep-level resource.

{Repeatedly copy branch-family instructions} For every executed branch-family instruction, copy its detailed description to Evidence. This particularly includes even destination I-address, plus the direction of the branch, plus the program-counter for this instruction. For more discussion, see elsewhere in this invention concerning “negative symptoms”.

The reporter also may provide pre-defined sustained instruction-oriented reporter methods, such as described below. When such a reporter method is invoked, it extracts and saves evidence approximately steadily, until explicitly halted. Such a reporter method may use the following structures. As each instruction completes execution, the augmented reorder buffer provides an augmented detailed description of the instruction and its direct results. The reporter includes a register for the detailed description of each instruction, Reporter Gates and Data Paths that connect from the augmented reorder buffer to the L2 cache, to main memory and to a file in storage. There are reporter flags and codemark flags that together modulate the reporter gates. This reporter method includes a procedure for the reporter sequential logic. This procedure is stored in the reporter memory. This can be loaded from the central-processor and memory hierarchy. This reporter method operates as follows. The reporter method procedure operates in the reporter sequential logic, and assigns values to reporter flags that modulate reporter gates. Also, codemark flags modulate the reporter gates. Thus some (none, part, all) of the detailed description is extracted and saved through reporter data paths. This continues until the reporter flags values are re-assigned. Examples of such reporter methods follow.

{Steadily copy the Detailed Description to Evidence} This reporter method steadily extracts and saves every detailed description to the evidence buffer in L2 cache, and/or to the evidence buffer in main memory. To support this reporter method, one arrangement adds a logical gate and data path from the source of the reorder stream to the L2 cache controller for the L2 cache. When this gate is opened, this data stream is fed to the evidence buffer. This reporter method extracts and saves very detailed evidence, with very large average data-rate. This can facilitate diagnosis of some bugs. However, this can time-distort execution, and complicate diagnosis of other bugs.

{Selectively copy the Detailed Description to Evidence} In some cases, better extraction (selection, modulation) of evidence will provide enough well-chosen evidence for effective diagnosis, but nevertheless significantly reduce the average data-rate and reduce time-distortion. In one example, the evidence is modulated based on the op-code (operation code, verb) of each instruction. The current Detailed Description is strobed into the detailed description Register, and its op-code is compared with specified op-codes. This drives a reporter gate that modulates the data path to an evidence buffer. One example is to select and to extract and save only memory-write instructions. This largely captures the “state” of the central-program execution. This is useful to diagnose Bugs as described in “Example A” in the “Examples” section. Another example is to extract and save only branch-family instructions, including all destination instruction-addresses. This is useful to diagnose certain bugs, as described in “Example C” in the “Example” section.

The following features apply to all or many reporter method.

{Circular buffers and pointers} In many cases, this structure enables writing and reading to occur almost simultaneously. Thus the circular buffer can save evidence even with substantial data-rate and large block-size. Since the circular buffer is a deep-level resource, this is often compatible with execution of the central-program.

{Time-stamps} The section on “Sentry” described a time-clock and time-stamp. As evidence is extracted, it may include a time-stamp often enough to clarify adequately the sequence of evidence. It is therefore desirable to include a time stamp whenever there is time overlap or time inversion between successive pieces of evidence. Also, it is desirable to include a time-stamp in each large block of evidence. Optionally, a time-stamp may be included when there is a significant time gap between successive evidence segments.

{Address translation} In one example, evidence in L2 cache includes an address tag, and evidence in main memory or in storage includes an address translation table.

{Modulation} Modulation enables limited customization of reporter methods. This modulation is a deep-level resource, compatible with execution of the central-program. The debugger may provide an interface, wizard or high-level function that enables a less-skilled operator to program this deep-level modulation. Thus a less-skilled operator is enabled to concentrate evidence where it has the hypothetical highest value. This provides an appropriate balance between simplicity and logical power.

Additional utility reporter method may be provided, as shown in the examples below.

{Flush Evidence Buffers to Storage} Flush from L2 evidence buffer to main memory evidence buffer to storage evidence file. The reporter sequential logic may direct controllers for the L2 cache, main memory, and storage to transfer this data.

{Halt} Halt operation of pre-defined sustained reporter method.

{Invoke other reporter methods} This reporter method is expressed as procedure that operates on the reporter sequential logic. This procedure can invoke none, one or more other reporter methods, including pre-defined reporter methods. In many cases, the operator uses the preparation software to create a compound reporter method, and/or to interact with software in the central-program.

For many cases, pre-defined reporter methods are convenient and efficient and powerful. However these are finite and pre-defined. In certain cases, more specialized reporter methods may be justified. An expert developer may construct software to extract and to save specialized evidence. This software is augmented by deep-level resources. In one example, the reporter method software is invoked by the deep-level resources in the sentry. In another example, this evidence is saved through a deep-level path to L2 cache or main memory. A reporter method including software may have important limitations, and may require a developer with special skills. For example, such reporter methods may be feasible only for evidence with relatively small data rate, and may incur time-distortion during execution. Nevertheless, this may be useful in particular cases.

Scribe

The scribe software operates during execution of the central-program. The scribe software controls the means to transfer data, from an evidence buffer in main memory to an evidence file in storage. More completely, the scribe supports the following functions: (i) the sentry, reporter or central-program can activate the scribe; (ii) the scribe can initialize an evidence file in storage; (iii) the scribe can transfer data from an evidence buffer in main memory to an evidence file in storage; (iv) scribe transfers can be done steadily, while data is written into a circular buffer so that newer evidence can be transferred into the evidence buffer by the sentry, while almost simultaneously older evidence is transferred out to an evidence file in storage; (vi) the evidence buffer can be “flushed” to the evidence file in one shot; (vii) the scribe and reporter together transfer evidence from an evidence buffer in L2 cache to an evidence file in storage; and (viii) the scribe can close an evidence file in storage.

In one arrangement, the scribe includes scribe sequential logic and scribe memory. This is programmed with a method for each scribe function. The scribe sequential logic interacts with the following elements: the software resources for MMF; the deep-level resources for a circular buffer in main memory; and the reporter. The scribe functions correspond closely to functions provided by these three elements. This permits the scribe sequential logic and scribe memory to be especially simple. In one arrangement the scribe is implemented using an extremely small co-processor and memory. This enables additional scribe methods for additional scribe functions. Thus a specialized expert can add more scribe functions. Another arrangement uses sequential gate logic that directly implements a fixed finite state machine. This supports pre-defined scribe functions, but this may restrict additional scribe functions.

There are on-going improvements in the design of a central-processor, such as the nearly simultaneous execution of multiple threads of instructions in a single processor. In such a processor, the scribe may be implemented as an additional thread that executes in the central-processor, but is almost simultaneous with and independent of the central-program. The scribe and execution of the central-program share use of the following: main memory, files in storage, and bandwidth to storage. In one arrangement, the scribe is allocated about 50% of main memory and allocated one file in storage. When both scribe and execution request bandwidth, each is allowed about 50%. When only one requests bandwidth, it is allowed almost 100%. Conversely, the execution is allocated about 50% of main memory, and about 50% of data bus bandwidth. It is likely this sharing of resources will not strongly degrade the average cycles per instruction for execution. It is important that, in many cases, transfer of evidence to storage is quite compatible with full speed or near full speed execution of the central-program. Nevertheless, the evidence transfer can still use a significant fraction of the main memory, logical size, bandwidth to Storage, and Storage.

Preparation Software

Based on examination of failure evidence, the developer or operator creates a hypothesis: what software events (landmarks) during execution might better surround the bug; what new evidence might better clarify the bug; what central-program segments might be more or less relevant to the bug. Based on this hypothesis, then the developer uses the preparation software to prepare (to aim, to program, or to configure) the sentry, the reporter, and optional software modifications to the central-program. For example, some software modifications may be made to specify where in the central-program to extract evidence with more details, and where with less details. (Typically, in the central-program some addresses are assigned during execution. This are called “dynamic addresses”.) Some software modifications may also feed dynamic addresses into the sentry and reporter, for example. When software modifications are made, the central-program is generally recompiled. This integrates the software modifications as above. Also this may be used to introduce compilation features for debugging. For example, compilation is aimed at simplest execution, rather than fastest execution. Also, Source-code statements and names are included as comments in the machine code.

The preparation software may be used to assist a less-specialized operator to (i) program the sentry; this includes specification of each landmark and its corresponding action; (ii) program the codemarks; these are specified by small additions to the central-program; (iii) program the reporter; this includes specification of the reporter method(s) for each landmark and codemark; (iv) to program additions to the central-program; this specifies codemarks, and specifies some parameters for the sentry or reporter; the latter are addresses or expressions assigned or evaluated during execution; (vi) to recompile the central-program; this integrates the above small additions, and includes “debugging hooks”.

The preparation software may provide a list of pre-defined diagnostic questions. The operator chooses among these. The operator specifies relevant parameters. These may be specified as a numerical constant or as a source-level expression plus its context. The operator specifies a name for this landmark, and specifies a value to assign the landmark flag. The preparation software also may provide a list of reporter methods, and the operator chooses from these. Based on the operator's inputs, the preparation software generates a program(s) for configuring the sentry.

The preparation software may also assist the operator to specify how to extract and save evidence with the reporter. The preparation software provides a list of landmarks, and the operator chooses among these. The preparation software provides a list of pre-defined reporter methods, and the operator may choose one or more. For each sustained reporter method that is chosen, then this operator provides a list of criteria to halt its operation, and the operator chooses among these. Based on the operator's inputs, the preparation software generates a program(s) for configuring the reporter.

Only moderate skills are needed for an operator to use the preparation software as described above. Thus an operator is provided with simple to use but powerful means to prepare the sentry and reporter and related small modifications in the central-program. This enables systematic and efficient diagnosis of many bugs, even with limited programming and development skills. In one example, the sentry preparation software and reporter preparation software each provide an interface program or wizard program. This may include choice boxes to show options, and entry boxes to enter expressions and context. There is on-going progress in computer-human interaction, which will provide additional means for interaction that can be incorporated here. Thus, one less specialized in the programming field can effectively use the debugging system with the preparation software.

The preparation software may provide a menu(s) of pre-defined programs for the sentry, for example: a diagnostic question; a corresponding test for a landmark; a corresponding action; a reporter methods; or means to enter parameters for each of the above. Likewise, the preparation software may provide predefined reporting methods. Thus a less specialized operator can easily feed specifications into the reporter. These pre-defined menus may be used to support each diagnostic question and each reporter method available in the system, or a selected subset thereto. Also, the preparation software enables a more-specialized expert developer to construct freely additional elements to diagnose additional bugs. This encourages a growing archive of sentry-programs that can be reused by less-specialized operators. Likewise, the preparation software allows a more specialized expert developer to program or configure the reporter. Thus the expert has the option, power, and challenge of writing a new reporter method to extract and save evidence during execution.

One useful landmark definition is to write to memory at a specified address. In some cases, the address is best specified as a fixed numerical virtual address. For example, an earlier execution was halted by an invalid read at this address, and this triggered a small “dump”. When the central-program is re-executed, this halt and this address are repeated. Thus the numerical address is well-defined, even if the operator lacks further understanding of this address. In other cases, the specified address is best expressed as a source-code symbolic address, such as local variable UU in method MM( ) in Method Main( ). This is specified as an expression and a context stack:
expression=“AddressOf(UU)”
context=“Method MM( )”
context=“Method Main( )”

### (The syntax for an expression and its context depends on the language of the source-code.)

Memory space for UU is allocated and assigned when method MM( ) begins to execute under Main( ). Only then (in this scope) is a numerical virtual address meaningful for this expression and context stack. During this scope, this virtual address is evaluated by the central-processor, and then passed to the sentry. Preparation software helps the operator to prepare (to program or configure) the sentry and reporter. The preparation software provides both means to enter a numerical expression, and means to enter an expression and context stack. Based on this, a statement(s) is injected into the source code for Method MM( ) under Main( ), or instructions are injected into the machine-code for Method MM( ) under Main( ).

Another landmark definition is to write to memory at a specified value to a specified address. Value specification depends on how and when to evaluate a specified value. In a first cases, the specification is a fixed numerical value. In a second case, the specification is an expression and context stack that are evaluated once, and passed to the sentry. In a third case, the relevant value changes frequently. The landmark consists of a preliminary test conditionally followed by an additional test. The preliminary test uses already-evaluated parameters. The additional test can be more complex. In one example, the preliminary test is for any write at a specified address. Next conditionally, the additional test uses the codemark flag (to evaluate the instruction address where this occurred). Next conditionally and optionally, the sentry interrupts the central-processor. This evaluates the specified expression and context stack, sends this to the sentry, and resumes execution. The sentry compares the newly evaluated value against the value that had been written to memory. If all these conditions are fulfilled, then a landmark is triggered, and the sentry takes corresponding action. Therefore, preparation software supports several specification options: (i) specification of a fixed numerical value or address; (ii) specification of an expression and context evaluated relatively early during execution; (iii) specification of a preliminary test based on an expression and context evaluated relatively early; and (iv) specification of an expression and context stack to be evaluated after passing the preliminary test.

The operator may use a codemark to modulate and to guide extracting and saving evidence during execution. A codemark injects a instruction(s) into the central-program, either at source-code or machine-code levels. The instruction(s) includes a value that is passed to sentry and hence to the codemark flag. Optionally this also includes a human-readable name. In some cases, such as for source-code the operator is actively developing, central-program source-code is available. In one use, the preparation software provides a source-code editor, and provides a source-code level function. As function arguments, the operator can specify a value and a human-readable name for this codemark. Thus the operator can inject a codemark. In other cases, such as library programs, only the machine-code is available. In this case, the preparation software may provide automatic means to find every method, and to construct a menu of these methods. The operator is provided with a display of these menus, and means to select a method and to assign a codemark value and optional human-readable name. Based on this, the preparation software will splice instructions into the program. Also, this facilitates broad-brush defaults, such selecting a large set of methods, and assigning a codemark value and name to each of these.

In the preparation software for the reporter, the operator can specify how to test the codemark flag(s) and hence how to modify gathering and saving evidence. In prior debugging processes, a common problem is to introduce an extra or new bug into the central-program when adding or removing code to diagnose an earlier bug. The new debugging system substantially reduces this problem. For example, the preparation software provides means “to clean” the central-program at source-code or machine-code levels. This automatically or semi-automatically finds and removes code additions described above related to the sentry, reporter or codemarks. In a variation, these additions resemble comment statements. Therefore these additions are disregarded during normal compilation. When a compile option is activated, the comments are parsed, and these additions are recognized and compiled.

Debugging may also be facilitated by options not otherwise needed for execution. For example, the source-code may be recompiled with the following options: (i) compile the above additions (sentry, reporter, codemark); (ii) by addition as comments in the machine-code, include source code names, statements and handles (for variables, methods, objects, classes); or (iii) generate the simplest machine-code, rather than more complex code that might be faster; and (iv) to generate address tables to clarify the correspondence between machine instruction and addresses and source code and symbolic variables.

Examination

The debugging system provides three software tools for examining the evidence file generated by the reporter: the exhibitor software, the detective software, and the replayer software. These three tools operate after execution and collection of the evidence file. These are off-line software programs that may run on the original computer system, or on a different computer system. These software tools help the operator to examine the evidence file. Given a time-stamp during execution, the exhibitor can display corresponding evidence in a human-readable style similar to source-code. The detective software automates searching for evidence that fulfill specified criteria The exhibitor and detective enable examination of the evidence file in time-forward order or time-reversed order. This facilitates working from a symptom back to the bug that caused it. The replayer software enables approximately resuming execution (or emulation) starting from a dump or very detailed snapshot of the state of the system.

The operator uses the exhibitor to inspect the evidence file. The exhibitor translates evidence data into a style similar to source code, and the display may be similar to a known debugger display. The exhibitor may also display a time-stamp with corresponding source code, values and addresses, and more. Because of causality, a bug must proceed the symptoms it causes. (In some cases, the bug is prolonged in time, and overlap with symptoms. An example is a software loop which does not terminate.) Therefore it is desirable to examine the evidence file in time-reversed order, from a later symptom to an earlier bug. Since the evidence file is pre-recorded, the exhibitor may move through the evidence file in time-forward or time-backwards order. Thus the operator can steer freely through the time-sequence of execution. However, the operator and the exhibitor can examine the evidence file at a finite and very limited maximum rate. In many cases this is quite useful and effective. However, in some cases, the evidence file is large, and the examination rate is inadequate. The detective software may assist in resolving this limitation. The detective software may provide a list of “diagnostic questions” that it tries to answer. The operator chooses one or more, and provides source-code expression to specify relevant parameters. Here are several examples:

Diagnostic Question 1=“Here is a landmark or codemark. When and how did this occur?”
Input=Select landmark or codemark from explicit list.
Search Method=Search through the evidence file; test each flag that occurred; detect if it matches this specification

Diagnostic Question 2=“Here is a range of D-addresses and a range of D-values. When and how was such a value assigned to such an address?”
Input=Provide source-code expressions to specify range of D-addresses and range of D-values.
Search Method=Search through the evidence file; detect when a value in this range was assigned to this range of addresses.

Diagnostic Question 3=“Here is a list of I-addresses. When and how was any of these I-addresses rejected by a Conditional Branch?”
Input=Specify a list of I-addresses. (In one use, the detective displays the source code, and the operator selects relevant statements).
Search Method=Search through the evidence file; for each branch-family instruction, test its rejected destination I-address(s); detect if a rejected destination is include in this set. This is particularly useful to diagnose a bug defined by non-execution of part of the central-program.

For each diagnostic question, the input may also enable the operator to specify the following: (i) the range of evidence file to search; (ii) the time-direction (time-forward or time-reversed) of the search; and (iii) which instance(s) to find that satisfies this specification; options include: first N instances, last N instances, all instances; here N is an integer specified by the operator. After each search, the detective lists the time-stamps that satisfies the search. The operator selects one, and uses the exhibitor to display relevant evidence.

The detective highlights several important aspects of the new debugging system: (i) the detective can search in time-reversed order; this facilitates going from a later symptom to an earlier bug; this is a major advantage compared to time-forward debugging; (ii) the search can be aimed at an evidence segment defined by specified markers, such as landmarks or codemark; this can concentrate on more interesting and relevant evidence, and avoid a flood of less relevant evidence; (iv) the search can evaluate evidence with specified level of detail; this can resist a flood of excessive details. After the detective reveals the specified time-stamp(s), the operator may manually steer the exhibitor to examine evidence more completely. In some cases, this can lead directly to diagnosis of the bug. In other cases, this can reveal an earlier symptom, and this process can be iterated to systematically find the cause of the failure.

For some central-programs and some bugs, the first evidence file may not be fully adequate for full and immediate diagnosis. Even so, in many cases the first evidence file will reveal or suggest other landmarks or other evidence hypothetically more closely correlated with a bug. Thus the operator can construct a better hypothesis, and hence a better sentry-program and reporter-program. Using these, the operator can again execute the central-program, and thus generate a new and better evidence file, which is likely to lead closer to the bug. This is symbolically indicated in FIG. 2.

The debugging system works readily for a central-program and bug that directly produce at least one clear-cut symptom that is known to the operator. One example is a bug which loads a known data address with a known improper value. In other cases, a bug is defined by a non-execution of part of the central-program. Thus a critical diagnostic question is: “Why did this software component NOT execute?”. This type of “negative bug” can be very challenging to locate and fix. Nevertheless, the debugging system provides means and teaches a method that often efficiently resolve this challenge. In solving this dilemma, the debugging system examines branch-family instructions. A branch-family instruction presents two potential destinations. One destination is “selected” or “taken”, and the other is “rejected” or “non-taken”. For bug diagnosis, both destinations can be useful inputs to the sentry and reporter. In particular, the rejected path directly indicates when and why some software section was not executed. This leads to the following diagnostic question: “When and why was this path (I-address) rejected by a Branch-family instruction”. In some cases, the un-executed software is part of a “stack” of software components which “should have” been executed and called each other. (i.e.: Method A called Method B called Method C), and one or more layers of this potential stack are not executed. This leads to a better diagnostic question: “Here is a set of I-addresses; when and why was any of these I-addresses rejected by any Branch-family instruction?” This diagnostic question is linked to a detective method that searches the evidence file, and detects any branch-family instruction which rejects any I-address in this potential stack. The sentry can detect a similar landmark: “Detect any Branch-family instruction which rejects any of these I-addresses”. In this way, the very challenging “negative bug” may be systematically located and fixed.

In some cases, adequate bug diagnosis may require very detailed evidence, particularly very “close” to the bug. It may not be convenient or feasible to extract and save such detailed evidence throughout execution. In some cases, a useful option is to extract and record a detailed “snapshot”. This may provide most of the “initial conditions” or “computer state” leading to a bug. During examination on a computer analogous to the central-processor, this snapshot and the central-program can be used “to replay” some execution. This may be augmented by the evidence file, particularly concerning interactions with external systems and external data. Therefore this invention provide “replayer” software. Given a “dump” or “snapshot” that very completely described the computer state at a time-stamp, then the replayer can approximately execute the program. However this approximation may be far from exact. Execution time and bandwidth may be distorted. Interactions between threads may be distorted. Interactions with complex software such as the operating system may be distorted.

During examination, the operator is free to explore, to experiment, to try different possibilities, and to discover what is useful. The user may use the exhibitor, detective and replayer a few or many times, to repeat as new things are learned. This flexibility helps the operator to harvest useful information from the evidence file. In very many cases, this will lead to creation of a better hypothesis. Often this will provide ideas about better use of sentry, reporter, landmarks, codemarks for future execution.

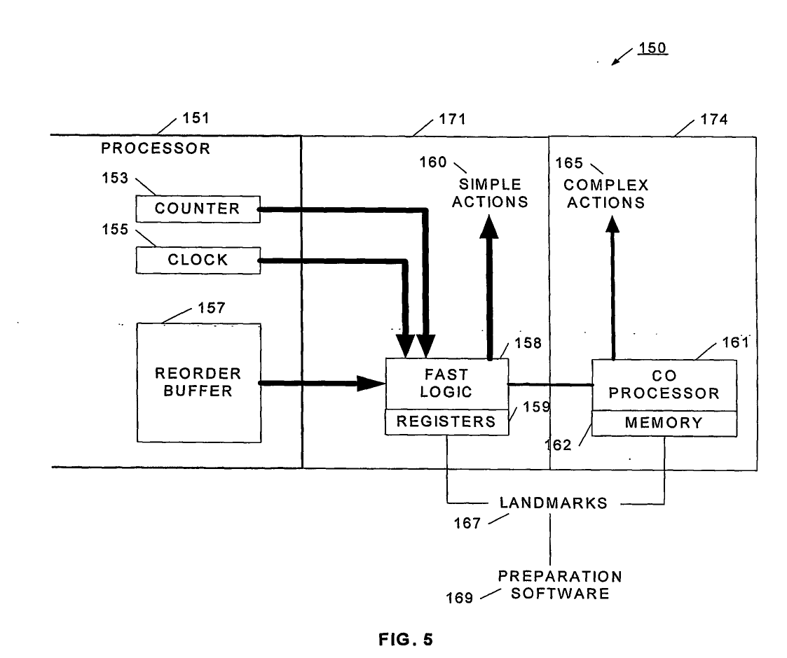

Referring now to FIG. 5, a debugger module 150 is illustrated, which implements one example of a sentry circuit. The debugger module 150 has a processor chip 151 which has a reorder buffer 157, the program counter 153, and a clock 155. These low-level assets are typical in a processor, but may be modified for improved utility in the debugger module. High speed data paths extend from the buffer 157, program counter 153, and clock 155 to the fast logic 158. The data paths, in one example, may be a data path extending from the processor chip 151 to external fast logic. In another example, the processor chip includes the fast-logic on-chip, as illustrated by the dotted line 171. By including the fast logic on-chip, the fast logic may more efficiently react to the low level assets, and enable the processor to maintain operation at or near full operational speed, even during the collection of data. The fast logic 158 may include high-speed registers 159, which are used to monitor the data from the low-level assets. The registers have been configured to monitor for one or more landmarks 167 or other software event. When the fast logic 158 detects a predefined landmark, the fast logic 158 generates an action signal 160 which may be used to trigger an activity. For example, the action could trigger the collection of evidence data, or stop the processor.

Since the fast logic operates with tight cooperation with the low-level assets, and it is desirable for the fast-logic to monitor the assets at or near the full processor speed, the fast logic 158 is most useful for detecting simple landmarks and activating simple actions. For more complex operations, the debugging module 150 may provide additional sequential logic. In one example, the sequential logic is provided as a co-processor 161. The co-processor 161 has a programmable memory 162 which may be programmed with more complex, compound logic functions or landmarks. For example, the co-processor may monitor for multiple events, some of which may be time-delayed, and take more complex actions 165 upon finding the compound software event. Since the co-processor may operate at slower speeds compared to the processor, the fast logic may selectively send data or actions to the co-processor. The co-processor may be external to the processor 151, or may be included on-chip as illustrated by the dotted line 174. By including the co-processor on-chip, the co-processor may more efficiently monitor events and more quickly perform actions.

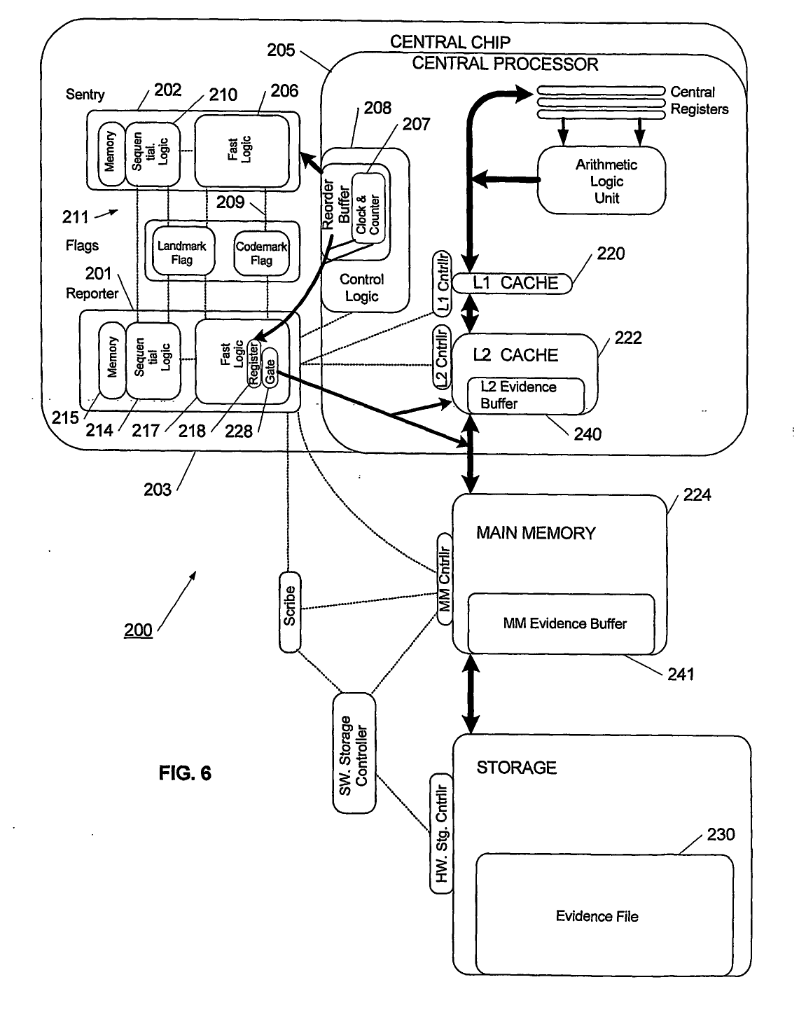

Referring now to FIG. 6, a debugger system 200 is illustrated, which implements one example of reporter circuit 201. FIG. 6 shows the reporter circuit 201 connected to an optional sentry circuit 202. In a manner similar to the sentry circuit 150 discussed with reference to FIG. 5, the optional sentry circuit 202 connects to a processor unit 205 which has a reorder buffer 208 and a counter and clock 207. The processor unit 205, as well as the sentry circuit 202 and the reporter circuit 201 are in processor chip 203. These low-level assets are typical in the processor, but may be modified for improved utility in the debugger module. High speed data paths extend from the buffer 208, counter, and clock to the sentry fast logic 206. By including the fast logic on-chip, the fast logic may more efficiently react to the low level assets, and enable the processor to maintain operation at or near full operational speed, even during the collection of data. The sentry fast logic 206 may include high-speed registers, which are used to monitor the data from the low-level assets. The registers have been configured to monitor for one or more landmarks or codemark or other software event. When the fast logic 206 detects a predefined landmark, the fast logic 206 generates an action signal 209 which may be used to trigger the reporter or a flag, or another activity. Since the fast logic 206 operates with tight cooperation with the low-level assets, and it is desirable for the fast-logic 206 to monitor the assets at or near the full processor speed, therefore the fast logic 206 is most useful for detecting simple landmarks and activating simple actions. For more complex operations, the sentry circuitry 202 may provide additional sequential logic. In one example, the sequential logic is provided as a co-processor 210. The co-processor 210 has a programmable memory which may be programmed with more complex, compound logic functions or landmarks. For example, the co-processor may monitor for multiple events, some of which may be time-delayed, and take more complex actions 211 upon finding the compound software event.

The reporter 201 has fast logic circuitry 217 with high speed data registers 218. The fast logic 217 connects to the high-speed data paths from the processor's 205 low level assets. The reporter fast logic 217 may optionally be constructed to received a trigger signal from the sentry fast logic 206. In this way, the sentry fast logic 206 may send a trigger signal to the reporter fast logic 217 when the sentry circuitry finds a configured landmark or other software event. If no sentry is provided, other triggering relationships may be used, or the reporter may continually or continuously extract data according to its configuration. Responsive to the trigger, action, or other event, the fast logic 217 may begin or alter how evidence is extracted and stored. The fast logic 217 may have been configured to extract data according to a reporter method or codemark. When the fast logic extracts data, it is passed to the L2 cache, for example. Although other memory or cache may be used, the L2 cache 222 is well-suited for connection to the fast logic 217. For example, the L2 cache 222 is fast enough to allow the fast logic 217 to pass data without significant impediment to the processor execution, but is large enough to hold a practical amount of evidence data. The L1 cache 220 may be useful for very high speed data needs, but its small size limits the amount of data that can be extracted without sharply degrading execution. In a similar manner, the main memory 224 may be useful for storing larger amounts of evidence data, but its use may impede or slow down execution of the central-program.

The fast logic 217 may also control a gate 228 on the high speed data path. The fast logic may place the gate in a condition where all data on the data path is sent to the L2 evidence buffer 240, or the main memory evidence buffer 241, or indirectly sent to the storage evidence file 230. These first two may each act as a high-speed circular buffer. The circular buffer is configured to accept new data, and as the buffer fills, older data is overwritten by newer data. In this way, the circular buffer always retains current and recent history data. Responsive to some software event, the fast logic 217 may configure the gate to stop passing the data to the circular buffer, and cause the circular buffer to dump its contents into the evidence file 230. The evidence file then contains a full data dump of the recent history for the software event. In a similar manner, the fast logic may also cause the L1 cache 220, the L2 cache 222, or the main memory 224 to be dumped into the evidence file 230.

For some reporter methods, the data for evidence does NOT pass directly through the reporter fast logic. Instead this data passes from the Processor thru evidence buffers in L2 cache, then main Memory, and then storage. This flow is guided by one or more controllers for the hierarchy (i.e.: L2 controller, main memory controller, software storage controller, hardware storage controller). The reporter supervises this flow through control lines. FIG. 6 also indicates these controllers and control lines. By modifying such control signals, the reporter can modulate the extracting and saving of evidence.

Since the reporter fast logic 217 operates with tight cooperation with the low-level assets, and it is desirable for the fast-logic 217 to extract data with large bandwidth from the assets at or near the full processor speed, thus the fast logic 217 is most useful for extract data based on reasonably simple comparisons or logic tests or locations. For more complex operations, the reporter circuitry may provide additional sequential logic. In one example, the sequential logic is provided as a co-processor 214. The co-processor 214 has a programmable memory 215 which may be programmed with more complex, compound logic functions or reporter methods. For example, the co-processor may monitor for multiple events, some of which may be time-delayed, and take more complex actions upon finding the compound software event. In one example, the co-processor receives a trigger, flag or data from the sentry co-processor 210, which indicates some compound or complex software event has occurred. Responsive to that trigger, the co-processor 214 may make further logical determinations, and cause some more complex action to be taken. For example, the co-processor may cause one or more hierarchy levels to dump to the evidence file 230, and to reset the evidence buffer(s) and prepare the evidence file for new data.

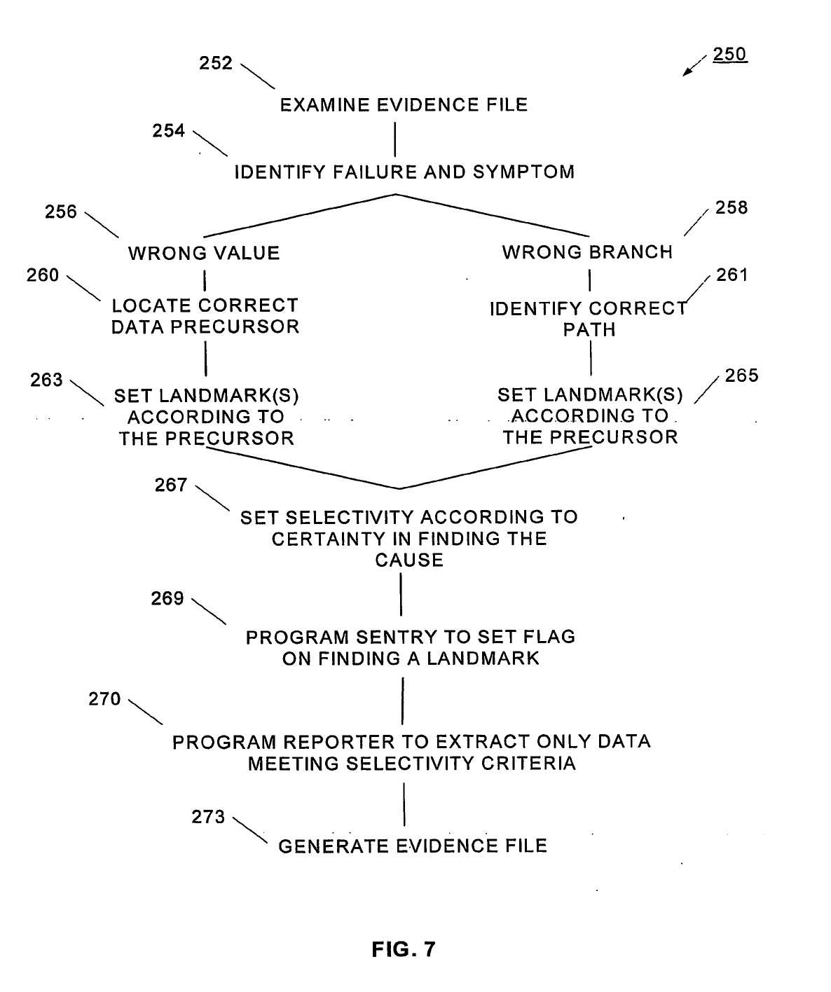

FIG. 7 illustrates a debugging process 250. The debugging process 250 provides a systematic way to locate the cause of a software failure or bug. In using the process, the operator first develops a hypothesis regarding the symptom, precursor, or cause of the bug. Once the debugging system has been configured to test the hypothesis, the operator executes the main software program, and the debugging system collects an evidence file, as shown in block 252. The operator then may review the evidence file to gain further insight into the symptom, precursor, or cause of the bug, as shown in block 254. In particular, the operator may find evidence that the cause of the bug is that the program is loading a wrong value 256 at some point, or that the program is not following an expected branch 258.

If the operator believes that the cause is of the wrong value type, then the operator will review the evidence file to find a precursor point where the data value was last correctly found, as shown in block 260. The operator, either in free-form or using a more structure preparation software, will define one or more landmarks that the operator believes will locate the precursor or symptom as shown in block 263. If the operator believes that the cause is of the wrong branch type, then the operator will surmise the expected path as shown in block 261, and will define a landmark that intends to identify the point when the program strays from the expected path. For example, the landmark could test for data that indicates that a particular branch was available, but the program did not take that branch.

With the landmarks defined, the operator then sets the level of extraction selectivity as shown in block 267. The operator sets reporter methods to define the granularity of data extraction, and may use codemarks to focus the data extraction on particular code sections or modules. Together, the reporter methods and codemarks enable the operator to configure the debugging system to provide the right information to narrow the search for the cause. The operator then sets the sentry circuitry to test for the defined landmark as shown in block 269, and sets the reporter circuitry to extract the desired level of data as shown in block 270. The operator may use the preparation software to configure the sentry circuitry and the reporter circuitry, or another process may be provided. Once the sentry circuitry and the reporter circuitry have been configured, the operator may again execute the software program. When the sentry circuitry finds the configured landmark, the reporter extracts the desired data. The data is then stored in an evidence file for review by the operator, as shown in block 273. The operator will review and analyze the new evidence file to find the cause, or to further refine the hypothesis for the cause.

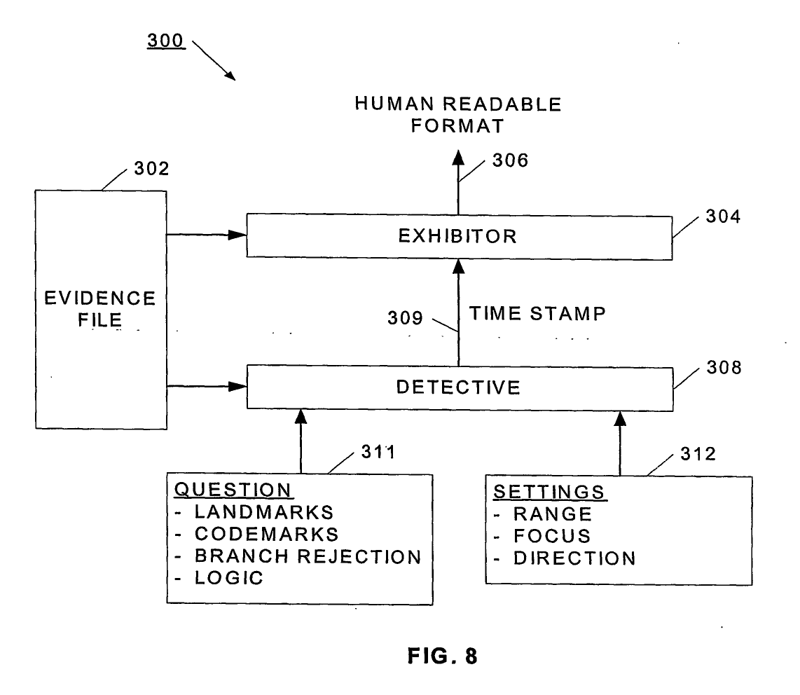

FIG. 8 illustrates one example process 300 of how a user may examine an evidence file. The evidence file 302 may be received into an exhibitor software 304 for review. The exhibitor enables the operator to view data in the evidence file in a more human readable format 306 for easier analysis. The operator may manually move through the evidence file to better understand the cause of the software failure. Because the evidence file is pre-recorded, the operator may move either forward or backward in time. However, because the exhibitor is a manual process, it can be very time consuming to move through a large evidence file, and an less experienced operator may not have the skills to readily identify meaningful evidence information. Therefore, the debugging process also provides a detective software 308. The detective software 308 is an automated tool that enables an operator to automatically analyze the evidence file to find points of interest. When the detective software 308 finds interesting data, the detective may report the time-stamp 309 to the operator or to the exhibitor, and the operator may use the exhibitor to review that evidence section in a human readable format. The detective software may have an interface, wizard, or structured menu to assist the operator in configuring the detective. For example, the detective 308 may have a set of predefined questions 311 that allow the operator to set landmarks, codemarks, branch inquiries, and logic comparisons in a manner similar to setting the sentry circuitry. In this way, the operator may automatically review the evidence file using terminology that assists in defining a hypothesis to generate the next evidence file. In a similar manner, the detective 308 may also have selectable settings 312 to allow the operator to focus the review of the evidence file. In one particularly important setting, the operator may set the detective to automatically review the evidence file in a time-backward manner. This is a powerful feature that allows the operator to find a result in the evidence file, and then automatically search through history to find information as to why the software reached that result.

Other Considerations

The debugging system is able to extract and save evidence in spite of the very large data-rate for some of the low-level assets. The evidence is constrained by the bandwidth between cache and memory (or between CPU and memory), and by the fraction of bandwidth allocated to evidence. In a typical personal computer, vintage 2004, using the Intel x86 computer architecture, a representative bandwidth is:

{4 Bytes per Bus-cycle}*{100E6 Bus-cycles per Sec}={4E8 Bytes per Sec}

In one example, this bandwidth is allocated 50% to evidence and 50% to execution of the central-program. This allocation is a reasonable tradeoff, because this makes a moderate degradation in each role, compared to using all the bandwidth for either role. This bandwidth limitation may be compared to the execution rate for instructions of the central-program. The germane ratio is the bytes of evidence per executed instruction of central-program. Often, these limitations can be greatly mitigated by the operator using the sentry to aim the evidence in the time-sequence of execution, and using the reporter to select the best level of detail. By contrast, using known software level debugging tools, the maximum Evidence bandwidth vastly smaller, such as 100× to 10,000×.

The debugging system can efficiently extract, save and examine evidence in spite of huge logical size. The binary size of the evidence file is constrained by hardware. Vintage 2004, relevant hardware can handle files up to scores or hundreds of gigabytes. The evidence file can be a significant fraction (e.g.: 50%) of this. Thus the evidence file can be huge. Another constraint is the ability of the operator to analyze the evidence file. Per hour of labor, the operator can likely use the exhibitor to examine a few thousand time-stamps. However, the detective enables automated searching, with a vastly faster rate.

During execution, the process of is extracting and saving evidence may time-distort (slow-down) execution. Some bugs are not effected by time-distortion. Others are moderately sensitive to time-distortion. Still other bugs pivot on execution timing details. In a preferred embodiment of this invention, as described above, the time-distortion is small to moderate (e.g.: time ratio between 1× and 3×.) This enables diagnosis of time-independent bugs, and bugs with moderate time-sensitivity. However this may not support efficient diagnosis of bugs with extreme time-sensitivity. Time-independent bugs tolerate slowing execution the central-program, and this allows storing very detailed evidence. This enables diagnosis of very pathological time-independent bugs. Bugs which are moderately time-sensitive allow only moderate evidence. Thus these enable diagnosis of less pathological time-moderate Bugs. Often, the operator can use the sentry to aim the evidence in the time-sequence of execution, and use the reporter to select the best level of detail. Used well, this selectivity can greatly mitigate distortion concerns. Thus, an operator can use the debugging system to diagnose systematically and efficiently many bugs, and to diagnose with intermediate efficiency many other bugs. This will considerably improve the average time invested to diagnose bugs.

The debugging system can be embodied upon a panorama of Processors, Hardware Modules, and Computer Systems. Some examples of alternative implementations are generally described below.

Plural-Threaded Processor: There is on-going development of a “plural-threaded” processor, which can execute almost simultaneously plural threads of machine instructions. As this technology progresses, this shall enable the following embodiment. An additional thread executing on the central-processor serves as sequential logic for the sentry and/or reporter. When this becomes sufficiently feasible, it will reduce the extra hardware required for this invention.

Plural-Processor Chip: There is on-going development of a “plural-processor” chip, which includes plural processors on a single chip. These processors can execute simultaneously plural threads of machine instructions. As this technology progresses, this shall enable the following embodiment. An additional processor on the same chip serves as the sequential logic for the sentry and/or reporter. When this becomes sufficiently feasible, it will reduce the extra hardware required for the debugging system.

Plural-Chip Module for Plural-Processor Module: There is on-going development of “plural-chip module”, with plural chips mounted closely together in one hardware module. Thus one module can include multiple processor chips. As this technology progresses, this shall enable the following embodiment: An additional Processor Chip in the same module serves as the sequential logic for the sentry and/or reporter. However, the feasibility depends on adequate connectivity and bandwidth between plural chips inside this module. When this becomes sufficiently feasible, it will reduce the extra hardware required for this invention.

Plural-Chip-Module including Processor and Cache: Another plural-chip module example includes plural different chips, particularly one or more processor chip(s) and one or more chip(s) for cache or memory. As this technology progresses, this shall enable an embodiment with very large cache. This shall enable a larger evidence buffer, and hence another embodiment oft his invention. One highly desirable embodiment uses the module described in U.S. patent application No. 20040108591, with inventors Philip Emma and Arthur Zingher, with title “Enhanced connectivity for electronic substrates, modules and systems using a novel edge flower terminal array”.

Embodiments with Enhanced Cache or Memory: In another embodiment, the hierarchy includes L3 cache. One example is the plural-chip module described above. Also other technologies may enable L3 cache. A such technology progress sufficiently, this may enable cache with relatively large logical size, and relatively large bandwidth to the processor. Therefore, it is particularly favorable to use part (e.g.: 50%) of this for a circular evidence buffer with large logical size and bandwidth. In certain cases, resources may be so abundant that it is feasible to assign fully distinct cache or memory to saving evidence and executing the central-program. This greater separation reduces the real-time interactions between execution and evidence, particularly multiplexing of access circuits. This increases the comparability between this invention and execution of the central-program.

Other Types of Processors: This invention can be embodied by tools and method to diagnose a bug on a sequential logic machine that executes a program. This may be described by another name, such as a “controller”, rather than a “coprocessor” or “computer”. Some examples are: a controller for a router; a controller for storage; a controller for a communication bus; a controller for memory or cache; and others.

Other Types of Computer Systems: The debugging system may be embodied across a spectrum of computers. Examples include: a “smart” cell-phone; a hand-size mobile client computer; a laptop mobile client computer; a desktop client computer; a web-server computer; an application-sever computer; a data-base server computer. Across this spectrum of embodiments, the parameters and details of an embodiment vary with the type of computer system. For example, in a small system with a communication link, the evidence file can be embodied by a communication link to a remote device. Relevant values for bandwidth and logical size also vary with the embodiment. Likewise, the pre-defined programs and diagnostic questions for sentry, reporter, and preparation software also vary with the embodiment.

Alternatives to Reorder Buffer: For a general purpose computer processor in the current vintage, there is considerable use of “Out Of Order” (OOO) and “speculative” execution of machine instructions, in order to improve the Instruction executed per cycle. Therefore these processors typically include a “reorder buffer”, as described above. However such a processor suffers from more power dissipation and more internal complexity. These are a disadvantage for a mobile system with very constrained battery. Even for stationary computer, these increase direct and indirect costs. There is considerable on-going research and development towards better internal engineering for processors. Therefore some processors do NOT include a reorder buffer. The debugging system can be embodied upon a processor without a reorder buffer. It is sufficient to include an internal asset(s) that provides details of an executed instruction, such as operation code (verb), data address, branch destination address(es), etc. For example, some processors have sub-units to parse an instruction into these components, then process each component. Some such processors do not have a reorder buffer

Separation versus Integration of Sentry, Reporter, Processor: For clarity, the debugging system has been described and illustrated by an example where the sentry, reporter and processor are quite distinct. However in other embodiments, these units are tightly integrated. Other implementations and arrangements may depend on the engineering history of the processor chip. If this closely follows a pre-engineered processor, then it is more compatible to use a separate sentry and processor. However, for a processor being engineered from the beginning, it is more efficient to integrate tightly the sentry and reporter into the processor. In particular, fast logic for the sentry and reporter can be integrated with other fast logic inside the Processor. Also, the sequential logic of the sentry and/or reporter can be combined with the processor. For example, see above concerning “plural-threaded processor”, “plural-processor chip”, “plural-chip module”, “plural-processor module”, and “module with processor and cache”.

Replay during Examination: In some cases, adequate bug diagnosis may require very detailed evidence, particularly very “close” to the bug. It may not be convenient or feasible to extract and save such detailed evidence throughout execution. In some cases, a useful option is to extract and record a detailed “snapshot”. This may provide most of the “initial conditions” or “computer state” leading to a bug. During examination on a computer analogous to the central-processor, this snapshot and the central-program can be used “to replay” some execution. This may be augmented by the evidence file, particularly concerning interactions with external systems and external data.

The Instruction Set Architecture or ISA was described above. Also, in known debugging systems, “firmware” or “microcode” is a level of programming deeper than the ISA. Typically, firmware is used by system engineers, but generally not used by software developers. The debugging system has generally been described as a means to diagnose a bug in software at ISA level. However this invention can be applied to other purposes, as discussed more fully below.

Software Performance Optimization: The debugging system can be used to guide performance optimization for software. In this case, evidence and examination are useful to extract, save and analyze performance details and statistics that measure and clarify performance of the central-program. In this case, the reporter methods typically extract information about execution timing. Some additional and specialized reporter methods may be useful for this application.

Firmware Debugging & Optimization: The debugging system can be used concerning firmware, to diagnose a bug or to guide performance optimization. This will be effective in cases where execution is sufficiently compatible between this invention and the firmware

Hardware Engineering & Development: In some cases, the debugging system can be used for engineering and development of computer hardware. This pivots on the compatibility between relevant hardware functions and this invention. For example, the debugging system can be useful concerning engineering and development of the hierarchy, including cache, main memory and storage, related hardware and firmware algorithms for data management in this hierarchy. The debugging system provides an efficient way to extract and save evidence, and to analyze statistics, concerning these functions concerning these functions. By contrast, in the prior art of computer engineering, it was often difficult to extract and gather such evidence.

Application for time-oriented bugs: The debugging system can be used for some time-oriented bugs, such as timing mis-coordination between plural threads of instructions. In this case, some reporter method are predefined to extract and record timing information, particularly the start-time, duration-time, end-time for execution of each method. Feasibility depends on execution compatibility between this invention, the central-program and the bug. As described-in this section, this is more useful for a bug with moderate time-sensitivity. However, a bug with extreme time-sensitivity may be obscured by operation of the debugging system.

Other Scenarios

Debugging on a Production System: It is common to develop new software off-line. The intent is to debug and to test the software fully, and thus to eliminate all bugs. Under commercial conditions, this intent rarely is achieved completely. Next typically, the software is transferred to “production” computers which process actual data for actual customers. Later, there may be occasional new requirements and new software development, and these introduce new bugs. Thus, in spite of intense efforts, nevertheless bugs pop up during production.

During late production, a bug may become rare. However, this rarity may be counter-balanced by the enlarged impact of an isolated bug. In many or most cases, it is never certain that software has zero remaining bugs. During late production, when a bug occurs, often it is clumsy or difficult to replicate adequately the bug, by transferring the software to an off-line computer system. This is particularly true if the bug involves interactions between plural systems.

Thus there is a permanent need for unobtrusive bug diagnosis, even on a production computer system. One comparison is an insurance policy. A second comparison is a spare tire for an automobile in the era before highly reliable tires and smooth roads. A third comparison is a security camera against theft. On a production system in many cases, the debugging system can be used in a background mode, to extract and save evidence unobtrusively and steadily. Typically this will gather and save evidence with relatively modest bandwidth. Typically this will not be examined unless there is an indication of a bug.

On a production system, after an indication of a bug, the debugging system can be redirected, to gather and save evidence with more details, more bandwidth, more specificity. Under these conditions, this pre-prioritization may be sensible. In many cases, this invention will considerably reduce the average time, impact, cost and risk to diagnose and correct a bug. Thus, even for a production computer system, this invention is permanently useful.

Remote debugging on a Client Computer: Some software is designed to operate on a “client” computer, with a User who is not a software developer. When the user observes a probe, the user reports it to a software developer. Often, the user provides inadequate evidence of the problem, and it is difficult for the developer to replicate the problem.

In this case, it is useful for the client computer system to include this invention. This allows the developer to send to the user a file to install on the client computer system. This file provides preparations for the sentry, reporter, etc. During subsequent execution, this can extract and save an evidence file. Later, the evidence file can be sent to the developer. In some cases, this can be iterated as per the convergent spiral method of the debugging system. Thus a developer can efficiently diagnose a bug in spite of the remoteness of the client system.

While the invention has been described in connection with a number of embodiments, it is not intended to limit the scope of the invention to the particular forms set forth, but on the contrary, it is intended to cover such alternatives, modifications, and equivalents as may be included within the scope of the invention.

What is claimed is:

1. A debugging system, comprising:
a processor constructed to execute a software program;
a fast-response circuit coupled to a low-level asset in the processor;
the fast response circuit configurable to extract selectively data from the low-level asset without major time-distortion of the software program executing on the processor; and
a data path constructed to transfer extracted sustained data to an evidence file.

2. A debugging system, comprising:
a processor constructed to execute a software program;
a fast-response circuit coupled to a low-level asset in the processor;
the fast response circuit configurable to monitor selectively sustained data from the low level asset for a predetermined event without major time-distortion of the software program executing on the processor; and
wherein the fast response circuit is constructed to transmit an action signal responsive to the event.

3. A debugging system, comprising:
a processor constructed to execute a software program;
a fast-response circuit coupled to a low-level data asset in the processor;
the fast response circuit having a first portion configurable to monitor data from the low level asset for a predetermined event, and constructed to generate an action signal upon the occurrence of the predetermined event;
the fast response circuit having a second portion configurable to extract selectively data from the low-level asset, and constructed to act responsive to the action signal; and
a data path constructed to transmit extracted sustained data to an evidence file without major time-distortion of the software program executing on the processor.

4. The debugging system of claim 1, 2, or 3, wherein the low-level asset is constructed as a commit buffer, a reorder buffer, a high speed data bus, or a register.

5. The debugging system of claim 1, 2, or 3 wherein the fast response circuit is integrated on-chip with the low-level asset of the processor.

6. The debugging system of claim 1, 2, or 3, wherein the fast response circuit comprises high speed registers.

7. The debugging system of claim 1, 2, or 3, wherein the data path comprises one or more resources of the processor's hierarchy.

8. The debugging system according to claim 3, further including:
sequential logic connected to the first portion of the fast response circuit; and
wherein the sequential logic is programmable to selectively monitor for program events, and the sequential logic enables an action responsive to the program events.

9. The debugging system according to claim 3, further including:
sequential logic connected to the second portion of the fast response circuit; and
wherein the sequential logic is programmable to selectively extract data.

10. The debugging system according to claim 8 or 9, wherein the sequential logic is constructed as a co-processor.

11. The debugging system according to claim 8 or 9, wherein the sequential logic is integrated on-chip with the low-level asset of the processor.

12. A processor chip, comprising:
a low-level asset;
a fast-response circuit coupled to the low-level asset;
the fast response circuit having a first portion configurable to monitor data from the low level asset for a predetermined event, and constructed to generate an action signal upon the occurrence of the predetermined event;
the fast response circuit having a second portion configurable to extract selectively data from the low-level asset, and constructed to act responsive to the action signal; and
a data path including one or more resources of the processor's hierarchy, the data path constructed to transmit sustained evidence data to an evidence file.

13. (canceled)

14. A processor comprising:
a low level asset;
a fast response circuit preconfigured to monitor for an event and to extract data selectively;
a high-speed data path constructed to transfer sustained data from the low level asset to the fast response circuit;
wherein the processor performs the steps of:
executing a central-program;
detecting the event using the fast response logic;
extracting data selectively using the fast response logic; and
transferring the extracted data to a memory; and
wherein the detecting, extracting, and transferring steps are performed without major time-distortion of the central program executing on the processor.

15. The processor according to claim 14, further comprising:
a second low-level asset connected to the fast response circuit; and
wherein the extracting step includes selectively extracting data from the second low-level asset.

16. The processor according to claim 14, further comprising:
a sequential logic circuit connected to the fast response circuit; and
wherein the processor performs the steps of:
transmitting an action signal to the sequential logic responsive to detecting the event.

17. (canceled)

18. (canceled)

19. A debugging system, comprising:
a processor constructed to execute a software program and having a shared high-speed data transfer bus;
a fast-response circuit coupled to a low-level asset in the processor;
the fast response circuit configurable to extract sustained data from the low-level asset; and
a high-speed data path extending to an evidence file, the high-speed data path including the shared high-speed data transfer bus.

20. The debugging system according to claim 19, wherein the high speed data path further includes one or more resources of the processor's hierarchy.

21. The debugging system according to claim 19, wherein the fast response circuit is constructed to extract the sustained data without major time-distortion to the software program executing on the processor.

22. The debugging system according to claim 19, wherein the high-speed data path is constructed to transfer the sustained data to the evidence file without major time-distortion to the software program executing on the processor.
